(19) United States
(12) Patent Application Publication
(10) Pub. No.: US 2025/0025894 A1
(43) Pub. Date: Jan. 23, 2025

(54) FLUID DELIVERY DEVICE

(71) Applicant: KOHLER MIRA LIMITED, Cheltenham (GB)

(72) Inventors: Leyton Iddon, Cheltenham (GB); Ben Lea, Cheltenham (GB)

(21) Appl. No.: 18/755,442

(22) Filed: Jun. 26, 2024

(30) Foreign Application Priority Data
Jul. 19, 2023 (GB) 2311087.7

(51) Int. Cl. B05B 1/16; B05B 1/18; E03C 1/04

(52) U.S. Cl. CPC B05B 1/1654; B05B 1/18; E03C 1/0408

(57) ABSTRACT

A fluid delivery device comprises an inlet, a plurality of outlets, a first chamber suppling fluid to a first selection of the plurality of outlets, a second chamber suppling fluid to a second selection of the plurality of outlets, and a switching device between the inlet and the two or more chambers. The switching device has a first operating mode in which there is a first fluid flow rate from the inlet to the first chamber and a second operating mode in which there is a second fluid flow rate from the inlet to the second chamber. In the first operating mode, a fluid flow rate from the inlet to the second chamber is not equal to the second fluid flow rate. The switching device cycles between the first operating mode and the second operating mode.

### CROSS-REFERENCE TO RELATED APPLICATIONS

This application claims priority to UK Patent Application No. 2311087.7, filed 19 Jul. 2023, the entirety of which is hereby incorporated by reference.

### FIELD OF THE INVENTION

The present disclosure relates to a fluid delivery device such as a spray head for a shower or a faucet. The present disclosure also relates to a plumbing or ablutionary system comprising such a fluid delivery device.

### BRIEF DESCRIPTION OF THE DRAWINGS

There now follows by way of example only a detailed description with reference to the accompanying drawings in which:

FIG. 1 illustrates an example fluid delivery device.

FIG. 2 illustrates an enlarged cross-sectional view of a portion of an example fluid delivery device.

FIG. 3 illustrates an example fluid delivery device.

FIG. 4 illustrates an enlarged view of a subsection of an example fluid delivery device;

FIG. 5 illustrates an enlarged cross-sectional view of a segment of an example fluid delivery device.

FIG. 6 illustrates an enlarged cross-sectional view of an example conduit assembly.

FIG. 7A illustrates an enlarged cross-sectional view of an example conduit in a first state.

FIG. 7B illustrates an enlarged cross-sectional view of an example conduit assembly in a second state.

FIG. 8A illustrates an example fluid delivery device.

FIG. 8B illustrates a cross-sectional view of an example fluid delivery device.

FIG. 9 illustrates a cross-sectional view of a portion of an example fluid delivery device

FIG. 10 illustrates a cross-sectional view of a portion of an example fluid delivery device.

FIG. 11 illustrates an example fluid delivery device.

FIG. 12 illustrates a cross-sectional view of an example actuator assembly.

FIG. 13 illustrates a cross-sectional view of an example actuator.

FIG. 14 illustrates an example ablutionary system.

### DETAILED DESCRIPTION OF THE DRAWINGS

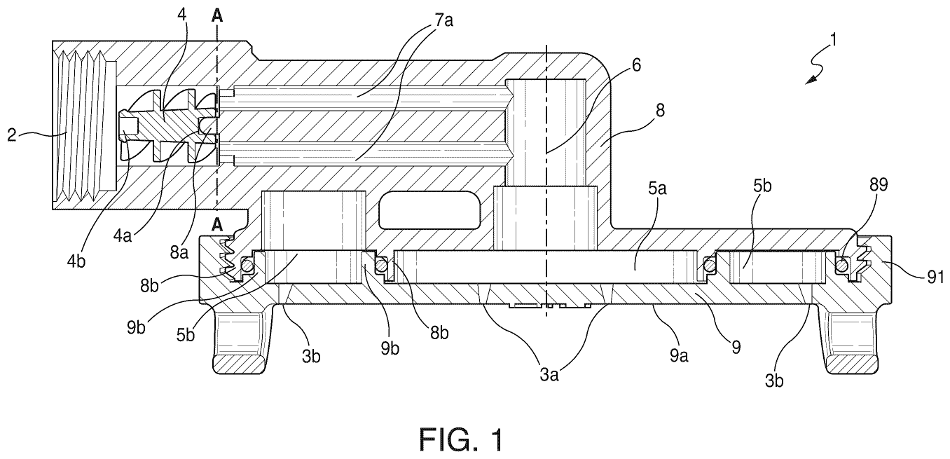

FIG. 1 shows a fluid delivery device 1. In this example, the fluid delivery device 1 is a spray head for a shower. Other fluid delivery devices, including but not limited to faucets or spickets are also envisioned. The fluid delivery device 1 comprises a body 8 having: an inlet 2, configured to couple to and receive fluid from a fluid supply-such as a pipe or other line (not shown), and a plurality of fluid delivery outlets 3a, 3b in fluid communication with the inlet 2. The fluid delivery device 1 also includes a first chamber 5a leading to a first selection 3a of the plurality of outlets 3a, 3b and a second chamber 5b leading to a second selection 3b of the plurality of outlets 3a, 3b. Other structures besides the first chamber Sa and second chamber 5b may be used, including but not limited to fluid supply lines and plenums. At least one of the first selection 3a of outlets and the second selection 3b of outlets comprises more than one outlet.

The fluid delivery device 1 further comprises a switching device 4 which is disposed in a fluid path between the inlet 2 and the plurality of outlets 3a, 3b. The switching device 4 is operable to control fluid flow to the plurality of outlets 3a, 3b. The switching device 4 is configured such that it has a first operating mode in which there is a first fluid flow rate from the inlet 2 to the first chamber Sa and a second operating mode in which there is a second fluid flow rate from the inlet 2 to the second chamber 5b. In the first operating mode, the fluid flow rate from the inlet to the second chamber is not equal to the second fluid flow rate though in some example embodiments, the fluid flow rates may be equal. During use of the fluid delivery device 1, the switching device 4 is caused to continuously cycle between the first operating mode and the second operating mode.

In this example, the first selection 3a of outlets and the second selection 3b of outlets each comprise more than one outlet. The first selection 3a of outlets and the second selection 3b of outlets each comprise numerous outlets arranged radially, in a ring, about a central axis 6 of the fluid delivery device 1. In other example embodiments, varying arrangements of outlets for both the first selection 3a and second selection 3b may be used. The central axis 6 passes through a centre of a spray face 9a, normal to the spray face 9a at this point. The cross-sectional view of FIG. 1 shows only two outlets of each of the first selection 3a of outlets and the second selection 3b of outlets.

The first chamber Sa is connected to the inlet 2 and the switching device 4 via one or more channels 7a, termed first channels 7a. Similarly, the second chamber 5b is connected to the inlet 2 and the switching device 4 via one or more channels (not shown), termed second channels.

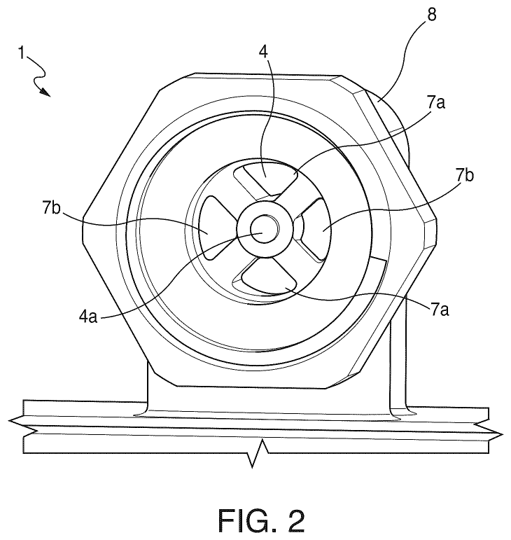

FIG. 2 is an enlarged view of a cross-section of the fluid delivery device of FIG. 1, taken through the line A-A. As shown in FIG. 2, the body 8 comprises two first channels 7a and two second channels 7b though other numbers of first channels 7a and second channels 7b may be used in other example embodiments. The first and second channels 7a, 7b are alternately spaced around a section of the body 8 such that the two first channels 7a lie opposite one another and the two second channels 7b also lie opposite one another. Thus, depending on the characteristics of the switching device, this configuration of channels 7a, 7b may ensure that a phase of flow in one of the two first channels 7a is the same as in the other of the first channels 7a. Similarly a phase of flow in one of the two second channels 7b is the same as in the other of the second channels 7b.

The first and second channels 7a, 7b may instead be positioned adjacent each other rather than opposite, or may have different radial spacing, depending on the configuration of the switching device 4.

In this example, the switching device 4 is a moveable element which rotates relative to the body 8. The switching device 4 may be a turbine or screw threaded rod, or a rotating plate with through-holes for aligning or misaligning with the first and second channels 7a, 7b. The switching device 4 may, at certain positions, partially or completely close openings to the first channels 7a and/or the second channels 7b. Alternately, the switching device 4 may not completely close openings to the first channels 7a and/or the second channels 7b at any position during its rotation. This may ensure there is always non-zero flow rate through both the first channels 7a and the second channels 7b.

Fluid flow rates to each of the first and second channels 7a, 7b are defined by inlet water pressure and size of opening between the switching device 4 and the respective channel 7a, 7b. Where the switching device is a turbine, the relevant opening is between the respective channel 7a, 7b and a turbine blade which eclipses said channel 7a, 7b.

Referring back to FIG. 1, the fluid delivery device 1 is shown with the switching device 4 in the first operating mode. In this mode, the fluid flow rate from the inlet 2 to the first chamber Sa is the first fluid flow rate. The fluid flow rate from the inlet 2 to the second chamber 5b is not equal to the second fluid flow rate. Upon rotation of the switching device 4, the switching device 4 switches from its first operating mode to its second operating mode and the openings between the blades of the turbine and the first and second channels 7a, 7b change. The fluid flow rate from the inlet 2 to the second chamber 5b changes to the second fluid flow rate. The fluid flow rate from the inlet 2 to the first chamber Sa also changes such that it is not equal to the first fluid flow rate.

As the turbine continuously rotates, the switching device (turbine) 4 continuously cycles between the first operating mode and the second operating mode. This may be beneficial, as a pulsing flow may be achieved, which may provide a suitable sense of water pressure to a user while minimising total water use. The fluid delivery device 1 may be configured such that, in use, the switching device 4 may rotate at approximately 200 revolutions per minute (RPM), though other RPMs may be utilised. A short pulse interval time may prevent a user from being aware that the flow rate from individual outlets is fluctuating. The provision of two selections of outlets 3a, 3b with temporally offset flow rate variation may further mask flow rate variation to a user of the fluid delivery device 1.

In this example embodiment, the switching device 4 is not powered. The switching device 4 is driven solely by fluid flow through the fluid delivery device 1. This may minimise the complexity, cost of manufacture and energy consumption of such a device, while improving safety to a user. In this way, cycling of the switching device 4 between the first operating mode and the second operating mode may be automatic and continuous. In other embodiments, the switching device 4 may be powered to drive rotation.

A resultant flow pattern of the fluid delivery device 1 may be varied by changing the shape and number of turbine blades of the switching device 4. For example, the number or pitch of blades may vary the pulse interval period for a given inlet fluid pressure. Further, in an example embodiment, more than two channels 7a, 7b, chambers 5a, 5b, and nozzle selections 3a, 3b may be used, as accommodated by different turbine blade configurations.

The fluid delivery device 1 may be configured to allow replacement of the switching device 4. This may allow the flow pattern of the fluid delivery device 1 to be chosen for a given application. FIG. 1 shows an example way in which the fluid delivery device may be configured to allow replacement of the switching device 4.

In this example, the switching device 4 is a turbine separable from the body 8. The turbine is disposed in a fluid path between the inlet 2 and the plurality of outlets 3a, 3b, and is coaxial with the inlet 2. The inlet 2 is configured to selectively couple to the fluid supply pipe or an adapter thereon (not shown) by means of a screw thread. A maximum diameter of the turbine may be less than a minimum diameter of the inlet (diameters being measured parallel to the axis of the turbine). This may allow the turbine to be removed or inserted from/into the fluid delivery device 1, through the inlet 2, during assembly.

Following assembly, the turbine is supported by and rotates about a projection 8a. The projection 8a is rounded and centrally located among the first and second channels 7a, 7b. The projection 8a extends from a plane, comprising end faces of the first and second channels 7a, 7b (shown by line A-A in FIG. 1) which face the switching device 4, toward the inlet 2. The projection 8a is received within a hollow 4a of the turbine. The turbine may be further supported by an additional projection (not shown) forming part of the fluid supply pipe or adapter thereof. This further projection may fit within an additional hollow 4b disposed on an axially opposite end of the switching device 4 to the hollow 4a. As will be apparent to those skilled in the art, various suitable configurations may be utilised to allow rotation of the turbine in use and separability of this component from the body 8. For example, in an alternate configuration, the projection 8a may form part of the turbine and the hollow 4a may form part of the body 8. In another example, an axial rod may extend through the switching device 4, about which the switching device 4 may rotate.

As shown in FIG. 1, the fluid delivery device 1 further comprises a detachable spray plate 9 including the spray face 9a in which the plurality of outlets 3a, 3b are disposed. In an in alternate arrangement, the spray plate 9 may instead be integrally constructed with the body 8, such that it is not detachable.

Each of the plurality of outlets 3a, 3b may be connected to a respective through hole spanning the full thickness of the spray plate 9. In this way, each of the first selection 3a of outlets may be fluidically connected to the first chamber Sa and each of the second selection 3b of outlets may be fluidically connected to the second chamber 5b. The spray plate 9 may comprise a plurality of nozzles (not shown), each of which fluidically connect to a respective one of the plurality of outlets 3a, 3b.

The spray plate 9 is generally planar and circular, though it is considered within the scope of this disclosure that other shapes may be utilised. A flange 91 extends from a perimeter of the spray plate 9, in a direction away from the spray face 9a. An internal surface of the flange 91 is threaded and couples to a corresponding threaded portion of an external surface of the body 8. This may allow the spray plate 9 to be replaced, for example, by an alternate spray plate 9 having a different pattern or number of outlets 3a, 3b. This may improve the level of customisation of the fluid delivery device 1. In another example embodiment, the spray plate 9 may attached to the body 8 via other attachment mechanisms, including but not limited to a snap fit or an adhesive.

A back face of the spray plate 9, opposite the spray face 9a, partially bounds the first chamber Sa and the second chamber 5b. The spray plate 9 comprises a series of first protrusions 9b which extend from the back face in a direction generally away from the spray face 9a. Similarly, the body 8 comprises a series of second protrusions 8b which extend away from the remainder of the body 8 towards the spray face 9a. Each first protrusions 9b is configured to cooperate with a respective second protrusion 8b of the body 8. Together, the body 8, back face of the spray plate 9, and first and second series of protrusions 9b, 8b form the first and second chambers 5a and 5b. A seal 89 such as an O-ring may be positioned, between each first protrusion 9b of the spray face 9 and its respective second protrusion 8b of the body 8, to prevent fluid escaping from the first chamber Sa and/or the second chamber 5b during use. In alternative example embodiments, protrusions may extend only from the spray plate 9 or the body 8, with a seal 89 positioned between the protrusion and the other corresponding face of the spray plate 9 or body 8. The second chamber 5b extends in an annulus around the first chamber 5a, though in other embodiments, other shapes may be used.

In the example shown in FIGS. 1 and 2, the switching device 4 is a moveable element which rotates relative to the body 8. However, it is considered within the scope of this disclosure that the switching element 4 may contain no moving parts.

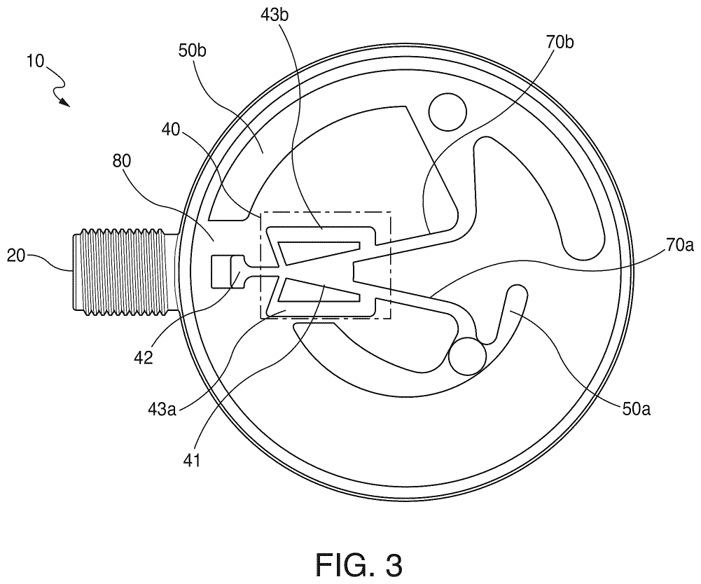

FIG. 3 shows a basal view of a fluid delivery device 10. The fluid delivery device 10 is a spray head for a shower and operates in a similar fashion to the fluid delivery device 1 of FIGS. 1 and 2. The main difference between these devices is that in the fluid delivery device 1, the switching device 4 is a moveable element which rotates relative to the body 8, while the fluid delivery device 10 is a fluidic oscillator and does not rely on any moving parts to continuously cycle between the first operating mode and the second operating mode.

Similarly to the fluid delivery device 1 of FIGS. 1 and 2, the fluid delivery device 10 comprises a body 80 having: an inlet 20, configured to couple to and receive fluid from a fluid supply pipe, line, or other source of fluid (not shown). The fluid delivery device 10 also includes a first chamber 50a and a second chamber 50b. The fluid delivery device 10 further comprises a switching device 40 which is disposed in a fluid path between the inlet 20 and the first and second chamber 50a, 50b. The first chamber 50a is connected to the inlet 20 and switching device 40 via a first channel 70a. Similarly, the second chamber 50b is connected to the inlet 20 and switching device 40 via a second channel 70b.

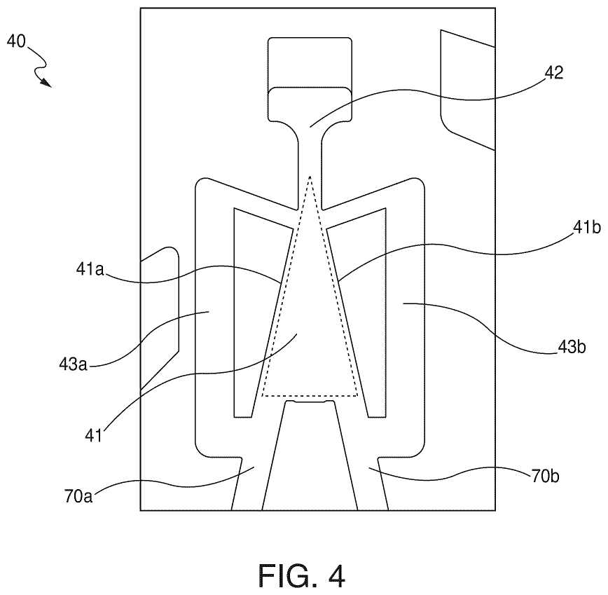

FIG. 4 shows an enlarged view of a subsection of FIG. 3, rotated 90° clockwise. The switching device 40 comprises an antechamber 41 having a generally triangular shape. The antechamber 41 is highlighted in FIG. 4 by white dotted lines. A port 42 fluidically connects the inlet 20 to the antechamber 41 at or around its apex. The first channel 70a and the second channel 70b connect to a basal edge of the antechamber 41 (on opposite sides of the antechamber 41). In this example, the first channel 70a and the second channel 70b connect to the antechamber 41 at opposite ends of the basal edge. The first channel 70a and the second channel 70b fluidically connect the antechamber 41 to the first chamber 50a and the second chamber 50b respectively.

The switching device 40 comprises a first feedback loop 43a which provides a path for fluid flow from the first channel 70a to the antechamber 41. Similarly, the switching device 40 also comprises a second feedback loop 43b which provides a path for fluid flow from the second channel 70b to the antechamber 41. The first feedback loop 43a and second feedback loop 43b are connected to opposing sides of the antechamber 41, termed a first side 41a and a second side 41b respectively. The first side 41a and the second side 41b of the antechamber 41 are segregated by a normal (virtual) to the basal plane projecting though the apex of the antechamber 41. The first feedback loop 43a is connected to a non-basal edge of the antechamber 41, such that the first feedback loop 43a and the first channel 70a are both connected to the first side 41a of the antechamber 41. Similarly, the second feedback loop 43b is connected to a further non-basal edge of the antechamber 41, such that the second feedback loop 43b and the second channel 70b are both connected on the second side 41b of the antechamber 41. In this example, both the first feedback loop 43a and the second feedback loop 43b are connected to the antechamber 41 near its apex.

In this example, the first feedback loop 43a and the second feedback loop 43b follow an angular path bounded by straight edges. However, it is within the scope of this disclosure that their paths be any suitable conformation such as meandering curved paths. As shown in FIG. 4, the first feedback loop 43a may be a mirror image of the second feedback loop 43b. In other implementations, the first feedback loop 43a and the second feedback loop 43b may not be mirror images of each other. The first feedback loop 43a and the second feedback loop 43b may be substantially identical to each other or may be different from each other.

The first feedback loop 43a is configured such that fluid flow from the first feedback loop 43a enters the antechamber 41 in a direction pointing substantially towards the second side 41b of the antechamber 41. Similarly, the second feedback loop 43b is configured such that fluid flow from the second feedback loop 43b enters the antechamber 41 in a direction pointing substantially towards the first side 41a of the antechamber 41. This configuration may permit flow from the first feedback loop 43a to disrupt flow to the first channel 70a. Similarly, the flow from the second feedback loop 43b may disrupt flow from the antechamber 41 to the second channel 70b. In this way, the switching device 40 is configured to function as described below.

The switching device 40 has a first operating mode in which there is a first fluid flow rate from the inlet 20 to the first chamber 50a. In the first operating mode, fluid enters the antechamber 41 through the port 42 and travels through the first channel 70a to the first chamber 50a and on to the first selection of outlets 30a. Fluid flow through the first channel 70a drives a portion of flow through the first feedback loop 43a and back into the antechamber 41. This disrupts the flow from the port 42 to the first channel 70a, thereby switching the switching device 40 into its second operating mode.

In the second operating mode, there is a second fluid flow rate from the inlet 20 to the second chamber 50b. The second fluid flow rate may be equal to or different from the first fluid flow rate. In the second operating mode, fluid enters the antechamber 41 through the port 42 and travels through the second channel 70b to the second chamber 50b. Fluid flow through the second channel 70b drives a portion of flow through the second feedback loop 43b and back into the antechamber 41. This disrupts the flow from the port 42 to the second channel 70b, thereby switching the switching device 40 back into its first operating mode. In this way, during use of the fluid delivery device 10, the switching device 40 is caused to continuously cycle between the first operating mode and the second operating mode. The fluid delivery device 10 does not rely on any moving parts to continuously cycle between the first operating mode and the second operating mode.

The switching device 40 is not powered, with switching driven solely by fluid flow through the fluid delivery device 10. This may reduce or minimise the complexity, cost of manufacture and/or energy consumption of such a device, while improving safety to a user. In this way, cycling of the switching device 40 between the first operating mode and the second operating mode may be automatic and continuous.

Fluid flow rates to each of the first chamber 50a and second chamber 50b are determined by inlet water pressure and the configuration of the two feedback loops 43a, 43b and the antechamber 41. For example, varying the diameter, length or curvature of the first feedback loop 43a and the second feedback loop 43b may vary the period of switching between operating modes and therefore a resultant flow pattern of the fluid delivery device 10.

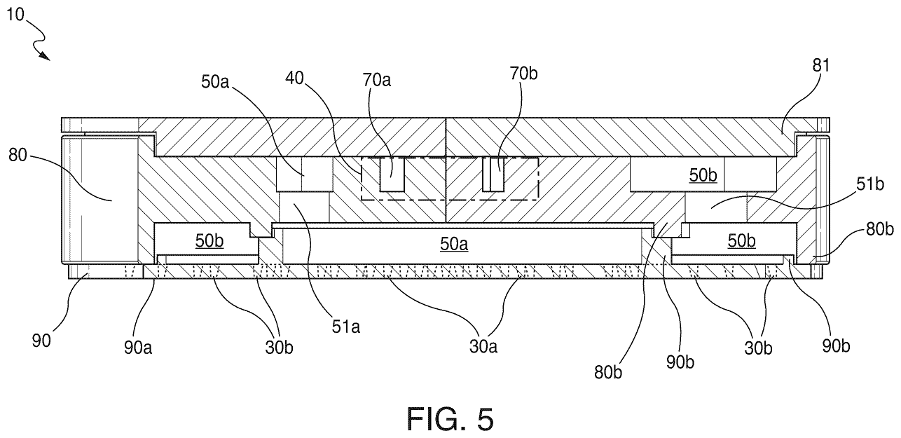

FIG. 5 shows a cross-sectional view of a segment of the fluid delivery device 10 of FIG. 3. As shown, the fluid delivery device 10 includes a plurality of fluid delivery outlets 30a, 30b in fluid communication with the inlet 20. The first chamber 50a is arranged to supply fluid to a first selection 30a of the plurality of outlets 30a, 30b and the second chamber 50b is arranged to supply fluid to a second selection 30b of the plurality of outlets 30a, 30b. The fluid delivery device 10 further comprises a detachable spray plate 90 having a spray face 90a in which the plurality of outlets 30a, 30b are disposed. In an alternate arrangement, the spray plate 9 may instead be integrally constructed with the body 8, such that it is not detachable. Each of the plurality of outlets 30a, 30b comprises a through hole extending through the full thickness of the spray face 90a. In this way, each of the first selection 30a of outlets is fluidically connected to the first chamber 50a and each of the second selection 30b of outlets is fluidically connected to the second chamber 50b. One or more of the outlets 30a, 30b may include a nozzle (not shown).

The continuous switching, between the first operating mode and the second operating mode, provided by the switching device 40 may beneficially produce a pulsing flow from the first selection of outlets 30a and the second selection of outlets 30b. This may provide a suitable sense of water pressure to a user while minimising total water use. The switching device 40 may be configured such that the interval between pulses is approximately 300 milliseconds. It is considered within the scope of this disclosure that other intervals between pulses may be used. A short pulse interval time may prevent a user from being aware that the flow rate from individual outlets is fluctuating. The provision of two selections of outlets 30a, 30b with temporally offset flow rate variation may further mask flow rate variation to a user of the fluid delivery device 10.

The spray plate 90 in generally planar and circular, though it is considered within the scope of this disclosure that other shapes may be utilised. A back face of the spray plate 90, opposite the spray face 90a, partially bounds the first chamber 50a and the second chamber 50b. The spray plate 90 comprises a series of first protrusions 90b which extend from the back face in a direction generally away from the spray face 90a. An outermost protrusion 90b couples with an internal surface of the body 80 forming, for example, a press-fit connection. The connection may allow the spray plate 90 to be replaced, for example, by an alternate spray plate 90 having a different pattern or number of outlets 30a, 30b. This may improve the level of customisation of the fluid delivery device 10.

The body 80 comprises a series of second protrusions 80b which extend away from the remainder of the body 80 towards the spray face 90a. Each first protrusions 90b is configured to cooperate with a respective second protrusion 80b of the body 80. Together, the body 80, the back face of the spray plate 90, and the first and second series of protrusions 90b, 80b form the first and second chambers 50a, 50b. Seals may be positioned, between each first protrusion 90b of the spray face 90 and its respective second protrusion 80b of the body 80, to prevent fluid escaping from the first chamber 50a and/or the second chamber 50b during use. In alternative example embodiments, protrusions may extend only from the spray plate 90 or the body 80, with a seal positioned between the protrusion and the other corresponding face of the spray plate 90 or body 80.

The body 80 comprises a top plate 81 which forms a top surface of at least part of the switching device 40. In this example, the top plate 81 forms a top surface of the antechamber; the first and second feedback loops; the first and second channels; and the first and second chambers 50a, 50b. Other portions of the body 80 may instead form the top surface of the antechamber; the first and second feedback loops; the first and second channels, and/or the first and second chambers 51a, 50b. The top plate 81 is selectively coupled to the remainder of the body 80 by way of one or more snap-fit connectors, though screw-type of adhesive connections may be used in some example embodiments. This may allow the fluid delivery device 10 to be more customisable as the top plate 81 may be replaced by a different top plate having different features (e.g., shape, material, colour, finish).

As shown in FIG. 5, the first chamber 50a and the second chamber 50b extend downward, towards the spray plate 90 through a first bore hole 51a and a second bore hole 51b respectively. The first chamber 50a is configured to at least partially extend beneath the switching device 40. In this way, the configuration of the first chamber 50a and the second chamber 50b in contact with the spray plate 90, may be selected independently of the shape and size of the switching device 40. This may allow, for example, some or all of the first selection of outlets 30a to be provided directly below the switching device 40, as shown in FIG. 5.

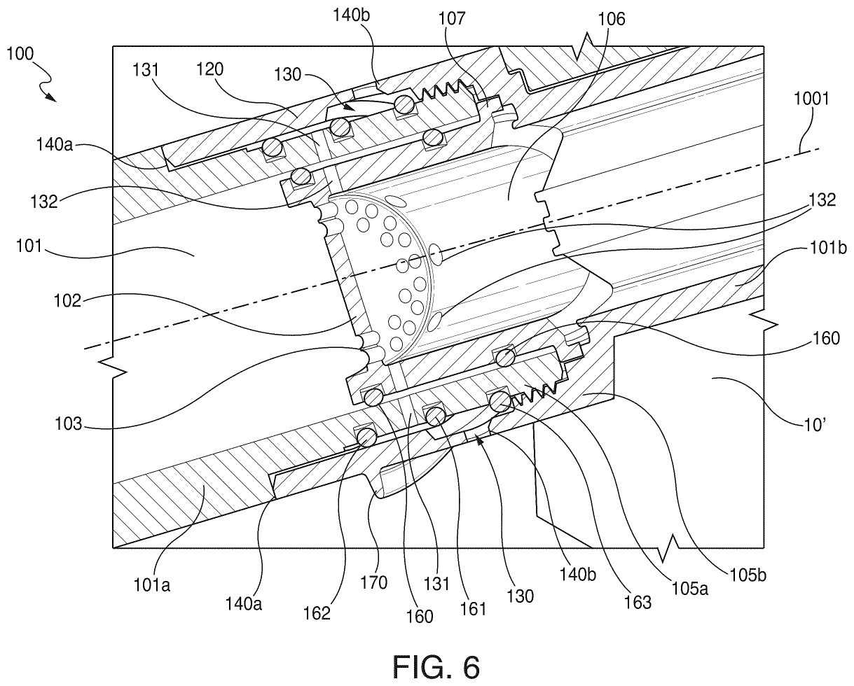

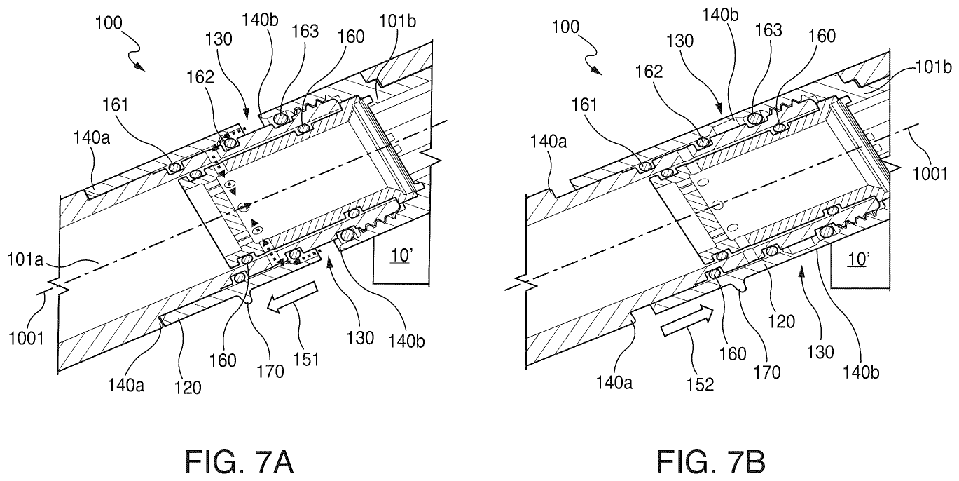

Referring to FIGS. 6, 7A and 7B, an enlarged cross-sectional view of a conduit assembly 100 for a fluid delivery device is shown. The conduit assembly 100 includes a conduit 101 configured to convey a fluid stream.

The conduit assembly 100 further includes a flow constrictor 102 configured to constrict flow of the fluid stream along the conduit 101, thereby producing, in use, a pressure drop in the fluid stream downstream of the flow constrictor 102.

The flow constrictor 102 is arranged within the conduit 101. In this embodiment, the flow constrictor 102 comprises a sheet oriented perpendicular to a longitudinal axis 1001 of the conduit 101. The sheet is perforated by a plurality of apertures 103. The plurality of apertures 103 are arranged in two rings proximal to a perimeter of the disc.

Alternate orientations and configurations of the flow constrictor 102 are considered within the scope of the disclosure. For example, the configuration of the plurality of apertures 103 may be varied to produce desired aeration levels.

In this example, the plurality of apertures 103 includes 32 apertures arranged in two rings proximal to a perimeter of the disc, though other configurations of apertures 103 may be used depending on desired aeration levels.

As a total flow area through the plurality of apertures 103 is substantially less than a flow area of the conduit 101, in use, the flow constrictor 102 produces a pressure drop in the fluid stream downstream of the flow constrictor 102. Other flow constrictor configurations that may be employed without departing from the scope of this disclosure will be readily apparent to a person skilled in the art. The flow constrictor may have any suitable configuration to produce a pressure drop in the fluid stream downstream thereof.

The conduit 101 is made from two generally tubular parts: a first part 101a and a second part 101b which are configured to selectively couple to one another. In this example, the first part 101a is upstream of the second part 101b. An end of the first part 101a proximal to the second part 101b has a reduced radius portion 105a which has a smaller external radius than a remainder of the first part 101a. A threaded portion is disposed on an external surface of the reduced radius portion 105a. An end of the second part 101b proximal to the first part 101a has an increased radius portion 105b which has a larger internal radius than a remainder of the second part 101b. A threaded portion is disposed on an internal surface of the increased radius portion 105b. The reduced radius portion 105a of the first part 101a is configured to fit at least partially within and threadingly engage with the increased radius portion 105b to selectively couple the first and second parts 101a, 101b of the conduit 101. A sealing member 163 having the form of an O-ring is configured to provide a fluid-tight seal between the first part 101a and the second part 101b of the conduit 101.

In other example embodiments, the conduit 101 may be integrally formed, or the first and second parts 101a, 101b may be connected in other ways, including but not limited to welding, sweating, snap fitting, and/or by adhesive.

The flow constrictor 102 forms one end of a hollow insert 106 which sits within the reduced radius portion 105a of the first part 101a. The hollow insert 106 includes a radially projecting rim 107 distal from the flow constrictor 102. The rim 107 is sandwiched between the reduced radius portion 105a of the first part 101a and the second part 101b. This configuration prevents translation of the hollow insert 106 along the conduit 101.

The conduit assembly 100 further comprises at least one, and in this example embodiment eight air induction channels 130 for conveying a stream of air from outside the conduit 101 into the conduit 101. The eight air induction channels 130 are distributed substantially evenly around a circumference of the conduit 101, though other configurations may be used. In this example, each one of the eight air induction channels 130 includes a one of a first set of air induction passages 131 which perforate the first part 101a of the conduit 101 and one of a second set of air induction passages 132 which perforate the hollow insert 106.

The first set of air induction passages 131 includes eight air induction passages regularly spaced around a circumference of the reduced radius portion 105a. The second set of air induction passages 132 includes eight air induction channels regularly spaced around a circumference of the hollow insert 106 proximal to the flow constrictor 102. Each of the second set of air induction passages 132 is arranged to receive air from a respective one of the first set of air induction passages 131 and provide air to an interior of the hollow insert 106.

Sealing members 160 are disposed on an external surface of the hollow insert 106 on either side of the second set of air induction passages 132. In the examples shown in the figures, each of the sealing members, such as sealing members 160 of the conduit assembly 100, is an O-ring. The sealing members 160 prevent fluid leaking from within the conduit assembly 100 along the first set of air induction passages 131 to outside the conduit assembly 100. Equally, the sealing members 160 also act to prevent air from entering the conduit assembly 100 upstream of the flow constrictor 102.

The conduit assembly 100 is configured such that air may enter the hollow insert 106 immediately downstream of the flow constrictor 102. At this point, in the conduit 101 there is a pressure drop and fluid flow is at a high velocity. This may beneficially ensure air is drawn along the air induction channels 130 and achieve effective mixing of the air into the fluid stream creating an aerated fluid stream.

The applicant has appreciated that it may be beneficial to allow selection between different flow characteristics of the fluid delivery device 10′. To this end, the conduit assembly 100 comprises an air induction channel closure means operable to actuate the conveyance of air along the air induction channels 130. In the illustrated example, the air induction channel closure means comprises a sleeve 120 operable to translate, relative to the conduit 101, parallel to the longitudinal axis 1001 of the conduit 101. The sleeve 120 is substantially tubular in shape and surrounds an outer circumference of the reduced radius portion 105a. An inner radius of the sleeve 120 is just greater than an outer radius of the reduced radius portion 105a to produce a close fit between the two pieces. An outer radius of the sleeve 120 is substantially equal to: an outer radius of the remainder of the first part 101a; and the increased radius portion 105b. In this way, the sleeve 120 sits flush with the first part 101a and the second part 101b of the conduit 101.

A step is formed at the junction between the reduced radius portion 105a and the remainder of the first part 101a, this step forms a first contact surface 140a for interaction with the sleeve 120 and acts as an end stop for translation of the sleeve 120 in a first direction 151. An end face of the increased radius portion 105b, proximal to the first part 101a, forms a second contact surface 140b for interaction with the sleeve 120 and acts as an end stop for translation of the sleeve 120 in a second direction 152, opposite the first direction 151. The sleeve 120 is operable to translate between two end points determined by the first end stop and the second end stop respectively, which define first and second states of the air induction channel closure means respectively.

The sleeve 120 further comprises a ridge 170 which enables user actuation of the sleeve 120 between the states of the sleeve 120. The ridge 170 projects away from the conduit 101 towards the fluid delivery device 10′. The ridge 170 may be substantially arcuate in shape, e.g., providing a crescent configured to fit a user's thumb.

FIG. 7A shows the conduit assembly 100 wherein the sleeve 120 is in the first state. In this state, a rear end of the sleeve 120 contacts the first contact surface 140a of the first part 101a. A front end of the sleeve 120 does not contact the second contact surface 140b of the second part 101b. As such, a gap is present between the front end of the sleeve 120 and second part 101b opening up the air induction channels 130. Two sealing members 161, 162 are disposed on an external surface of the reduced radius portion 105a on either side of the first set of air induction passages 131. A first of these two sealing members 161, distal to the second part 101b, acts to prevent air from entering the conduit 101 via the gap between the rear end of the sleeve 120 and first contact surface 140a. An internal radius of sleeve 120 increases towards the front end of the sleeve 120. This configuration ensures that in the first state, there is clearance between a second of the two sealing members 162 and the sleeve 120. In this state, the pressure drop in the fluid stream downstream of the flow constrictor 102 causes air to be drawn through the open air induction channels 130 to mix with the fluid stream in the hollow insert 106 to form the aerated fluid stream. The flow of air through the air induction channels 130 is shown by dotted arrows in FIG. 7A.

FIG. 7B shows the conduit assembly 100 wherein the sleeve 120 is in the second state. In this state, a front end of the sleeve 120 contacts the second contact surface 140b of the second part 101b, sealing the front end of the sleeve 120 against the second part 101b. As such, the air induction channels 130 are closed and no streams of air may be conveyed along the closed air induction channels 130 from outside the conduit 101 into the conduit 101. In this state, the fluid stream downstream of the flow constrictor 102 is not an aerated fluid stream. A gap is present between the rear end of the sleeve 120 and first contact surface 140a of the first part 101a. In this configuration, each of the two sealing members 161, 162 inhibits fluid (e.g., air or water) traversing between the reduced radius portion 105a and the sleeve 120. The second sealing member 162, proximal to the second part 101b, acts to prevent air from entering the condu it 101 between the front end of the sleeve 120 and the second contact surface 140a.

In an alternate configuration (not shown in the Figures), the sealing member 162 may instead be disposed on the internal surface of the sleeve 120 and a groove may be provided in the reduced radius portion 105a of the first part 101a. In this alternate configuration, the groove may be configured: to align with the sealing member 162 when the sleeve is in its first state to provide clearance between the sealing member 162 and the reduced radius portion 105a; and to be mis-aligned with the sealing member 162 when the sleeve is in its second state such that there is not clearance between the sealing member 162 and the reduced radius portion 105a.

The sleeve 120 may have one or more intermediate states between the first and second states. In such intermediate states, a small gap may be present between the interior surface of the sleeve 120 and the sealing member 162. When the sleeve 120 is positioned as such, the air induction channels 130 may be considered to be partially open and the resultant fluid stream may be aerated to a lesser extent than when the sleeve is in the first state. Provision of such intermediate states may allow a user finer control over the extent of aeration of the fluid stream.

Conventional actuation means, such as those that rely on relative rotation of two parts, can cause difficulty for a user whose hands are likely to be wet. Typically, such rotational actuation requires two hands, with one hand being used to secure each part. In contrast, for the present example, actuation can be achieved by user-controlled translation of the sleeve 120 with respect to the conduit 101 (with grip aided by ridge 170). Due to the positioning of the sleeve 120 on the handle portion 110 of the fluid delivery device 10′ and the provision of the ridge 170 to aid grip, a user may easily actuate the conduit assembly 100 with a single hand using their palm and fingers to grasp the handle portion 110 and their thumb to slide sleeve 120. In this way, the conduit 101 may provide an aerating means that can be easily actuated by a user without undue complexity which may result in high manufacturing costs.

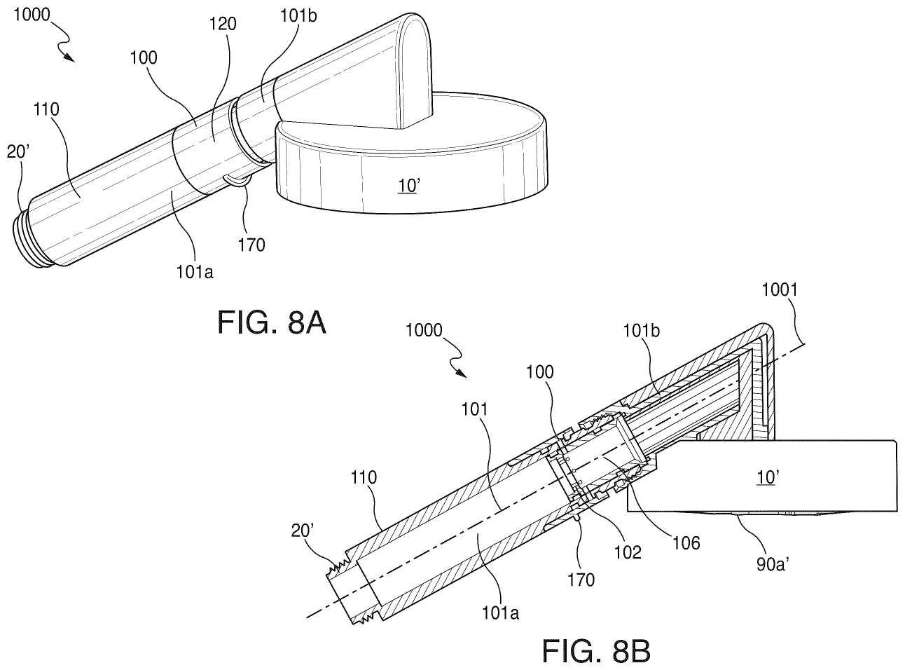

FIG. 8A shows a fluid delivery device 1000. FIG. 8B shows a cross-sectional view of the fluid delivery device 1000.

The fluid delivery device 1000 comprises a handset for a shower including a handle portion 110 and a head portion 10′.

A first end of the handle portion 110 comprises a threaded portion for connecting the handle portion 110, in use, to a fluid supply pipe (not shown). The handle portion 110 includes the conduit assembly 100. The conduit 101 is configured to convey a fluid stream through the handle portion 110 towards the head portion 10′. An inlet 20′ of the conduit assembly 100 is located at the first end of the handle portion 110. The conduit assembly 100 is shown in more detail in FIGS. 6, 7A and 7B and the accompanying description.

The head portion 10′ includes one or more internal chambers (not shown) in fluid communication with the conduit 101 and a spray face with a plurality of outlets for delivering fluid, in use, to a user. The head portion 10′ may include any suitable head portion of a handset for a shower.

In an example implementation, the fluid delivery device 1000 may include the fluid delivery device 1 or the fluid delivery device 10 described above downstream of the conduit assembly 100. For instance, any or all of the features of the fluid delivery device 1 or the fluid delivery device 10 as described above may be housed at least partially within the head portion 10′.

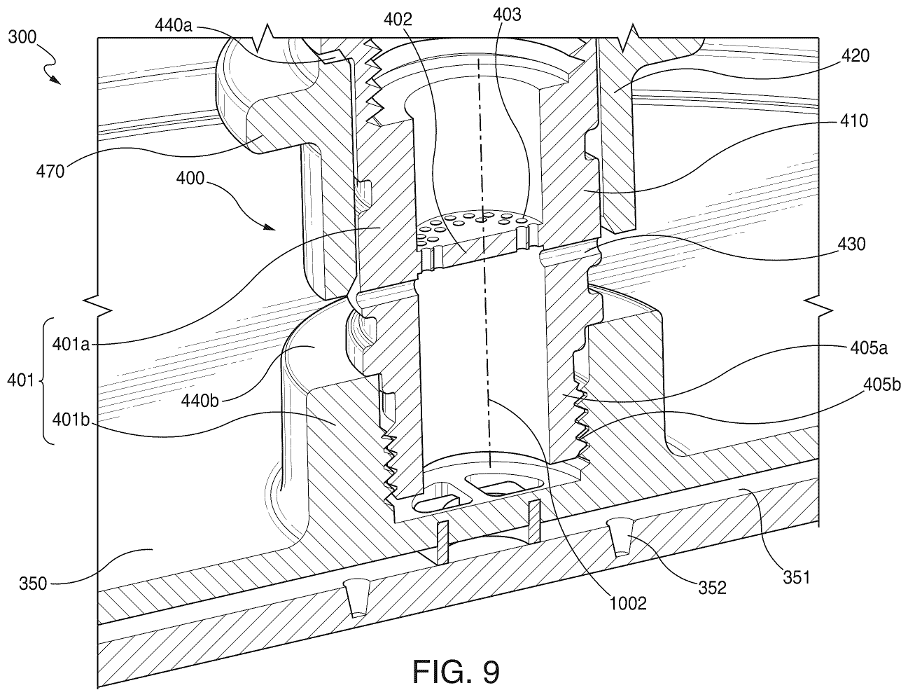

FIG. 9 shows a cross-sectional view of a fluid delivery device 300. In this example, the fluid delivery device 300 comprises a spray head 350 for a shower, but could alternately comprise other devices such as a faucet. The fluid delivery device 300 operates in a similar fashion to the fluid delivery device 1000 of FIGS. 8A and 8B. Similarly to the fluid delivery device 1000 of FIGS. 8A and 8B, the fluid delivery device 300 comprises a conduit assembly 400.

The conduit assembly 400 is configured to couple to a fluid supply pipe (not shown) and the spray head 350. The spray head 350 includes one or more internal chambers 351 in fluid communication with the conduit assembly 400 and a spray face with a plurality of outlets 352 for delivering fluid, in use, to a user.

The main difference between these devices is that the fluid delivery device 300 is a fixed overhead shower while the fluid delivery device 1000 is a handheld shower. As shown in FIG. 9, the conduit assembly 400 is integrated into a support pipe 410 that fixes the fluid delivery device 300 with respect to a shower enclosure in which the fluid delivery device 300 is installed. This is in contrast to the fluid delivery device 1000—shown in FIGS. 8A and 8B where the conduit assembly 100 forms part of the handle 110.

The conduit assembly 400 includes a conduit 401 configured to convey a fluid stream from the fluid supply pipe to the spray head 350. The conduit 401 is made from two generally tubular parts: a first part 401a and a second part 401b which are configured to selectively couple to one another. In this example, the first part 401a is upstream of the second part 401b and configured to couple to a fluid supply pipe. An end of the first part 401a proximal to the second part 401b has a reduced radius portion 405a which has a smaller external radius than a remainder of the first part 401a. A threaded portion is disposed on an external surface of the reduced radius portion 405a. A threaded portion 405b is disposed on an internal surface of the second part 401b. The reduced radius portion 405a of the first part 401a is configured to fit at least partially within and threadingly engage with threaded portion 405b of the second part 401b to selectively couple the first and second parts 401a, 401b of the conduit 401.

First part 401a includes a flow constrictor 402 configured to constrict flow of the fluid stream along the conduit 401, thereby producing, in use, a pressure drop in the fluid stream downstream of the flow constrictor 402. The flow constrictor 402 comprises a disc, perpendicular to a longitudinal axis 1002 of the conduit 401, perforated by a plurality of apertures 403. In this example, the plurality of apertures 403 includes 32 apertures arranged in two rings proximal to a perimeter of the disc.

As a total flow area through the plurality of apertures 403 is substantially less than a flow area of the conduit 401, in use, the flow constrictor 402 produces a pressure drop in the fluid stream downstream of the flow constrictor 402. Other flow constrictor configurations that may be employed without departing from the scope of this disclosure will be readily apparent to a person skilled in the art. The flow constrictor may have any suitable configuration to produce a pressure drop in the fluid stream downstream thereof.

The first part 401a further comprises a plurality of air induction channels 430 for conveying a stream of air from outside the conduit 401 into the conduit 401. The air induction channels 430 are distributed substantially evenly around a circumference of the conduit 401.

The conduit assembly 400 is configured such that air may enter the conduit 401 immediately downstream of the flow constrictor 402. At this point, in the conduit 401 there is a pressure drop and fluid flow is at a high velocity. This may beneficially ensure air is drawn along the air induction channels 430 and achieve effective mixing of the air into the fluid stream creating an aerated fluid stream.

The conduit assembly 400 comprises an air induction channel closure means operable to actuate the conveyance of air along the air induction channels 430. In the illustrated example, the air induction channel closure means comprises a sleeve 420 operable to translate, relative to the conduit 401, parallel to the longitudinal axis 1002 of the conduit 401. The sleeve 420 is substantially tubular in shape and surrounds an outer circumference of the first part 401a. An inner radius of the sleeve 420 is just greater than an outer radius of the first part 401a to produce a close fit between the two pieces.

A step is formed on the outer surface of the first part 401a which forms a first contact surface 440a for interaction with the sleeve 420 and acts as an end stop for translation of the sleeve 420 in a first direction. Another step is formed at the junction between the first part 401a and the second part 401b, which forms a second contact surface 440b for interaction with the sleeve 420. The second contact surface 440b acts as an end stop for translation of the sleeve 420 in a second direction, opposite the first direction. The sleeve 420 is operable to translate between two end points determined by the first end stop and the second end stop respectively, which define first and second states of the air induction channel closure means respectively.

The sleeve 420 further comprises a ridge 470 which enables user actuation of the sleeve 420 between the states of the sleeve 420. The ridge 470 projects away from the conduit 401 around a circumference of the sleeve 420.

FIG. 9 shows the conduit assembly 400 wherein the sleeve 420 is in the first state. In this state, a rear end of the sleeve 420 contacts the first contact surface 440a of the first part 401a. A front end of the sleeve 420 does not contact the second contact surface 440b of the second part 401b. As such, a gap is present between the front end of the sleeve 420 and second part 401b opening up the air induction channels 430.

When the sleeve 420 is in the second state, the front end of the sleeve 120 contacts the second contact surface 440b of the second part 401b, sealing the front end of the sleeve 420 against the second part 401b. As such, in this state, the air induction channels 430 are closed and no streams of air may be conveyed along the closed air induction channels 430 from outside the conduit 401 into the conduit 401. The fluid stream downstream of the flow constrictor 402 is not an aerated fluid stream. A gap is present between the rear end of the sleeve 420 and first contact surface 440a of the first part 401a.

Sealing members (not shown), such a O-rings, are disposed on an external surface of the first part 401a on either side of the air induction channels 430. The sealing members act to prevent air from entering the conduit assembly 400 when the sleeve 420 is in the second state.

Conventional actuation means, such as those that rely on relative rotation of two parts, can cause difficulty for a user whose hands are likely to be wet. Typically, such rotational actuation requires two hands, with one hand being used to secure each part. In contrast, for the present example, actuation can be achieved by user-controlled translation of the sleeve 420 with respect to the conduit 401 (with grip aided by ridge 470). In this way, the conduit assembly 400 may provide an aerating means that can be easily actuated by a user without undue complexity which may result in high manufacturing costs.

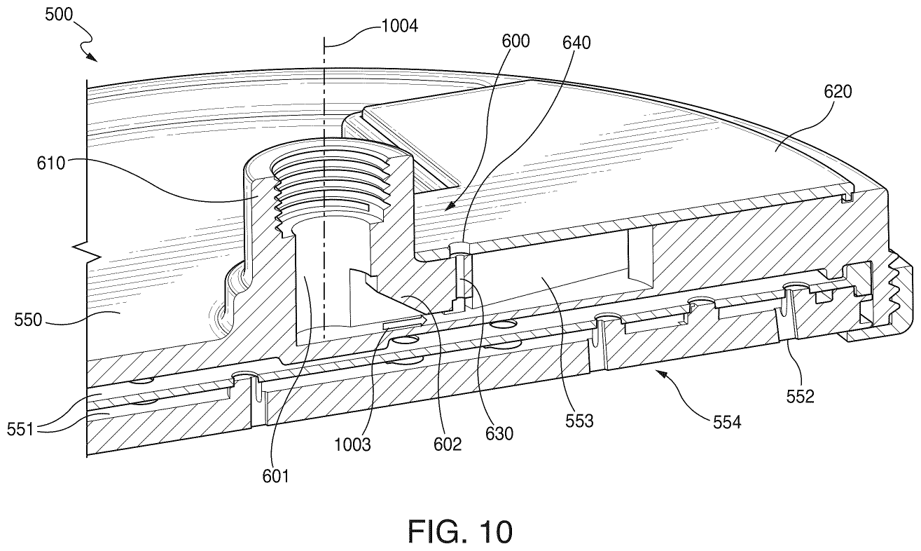

FIG. 10 cross-section view of a fluid delivery device 500. The fluid delivery device 500 comprises a spray head 550 for a shower and operates in a similar fashion to the fluid delivery device 300 of FIG. 9. The fluid delivery device 500 comprises a conduit assembly 600 which is configured to couple to a fluid supply pipe (not shown).

In this example, the spray head 550 includes a switching device 553 similar to the switching device 50 of FIGS. 1 to 3. The spray head 550 further comprises: one or more internal chambers 551 in fluid communication with the switching device 553; and a spray face 554 with a plurality of outlets 552 for delivering fluid from the one or more internal chambers 551 to a user. The conduit assembly 600 is integrated into and completely housed within the spray head 550. As in previous embodiments, the conduit assembly 600 is operable to selectively aerate flow travelling therethrough.

As will be described below, the conduit assembly 600 is configured differently to the conduit assembly 400 of FIG. 9. For example, the air induction channel closure means of the conduit assembly 400 comprises the sleeve 420 while the air induction channel closure means of the conduit assembly 600 does not comprise a sleeve and aeration of flow is instead actuated via rotation of a movable plate 620.

The conduit assembly 600 includes a conduit 601. The conduit 601 is configured to convey a fluid stream from the fluid supply pipe to the switching device 553.

The conduit assembly 600 includes a flow constrictor 602 configured to constrict flow of the fluid stream along the conduit 601, thereby producing, in use, a pressure drop in the fluid stream downstream of the flow constrictor 602. The flow constrictor 602 comprises section of the conduit 601 wherein a cross-sectional area progressively narrows in a direction 1003 of the fluid stream. Other flow constrictor configurations that may be employed without departing from the scope of this disclosure will be readily apparent to a person skilled in the art. The flow constrictor may have any suitable configuration to produce a pressure drop in the fluid stream downstream thereof.

Immediately downstream of the flow constrictor 602, the conduit 601 is perforated by one or more air induction channels 630 for conveying a stream of air from outside the conduit 601 into the conduit 601. At this point, in the conduit 601 there is a pressure drop and fluid flow is at a high velocity. This may beneficially ensure air is drawn along the one or more air induction channels 630 and achieve effective mixing of the air into the fluid stream creating an aerated fluid stream.

As mentioned previously, the conduit assembly 600 comprises an air induction channel closure means operable to actuate the conveyance of air along the one or more air induction channels 630. In the illustrated example, the air induction channel closure means comprises a movable plate 620 which forms a rear external surface of the spray head 550. The movable plate 620 is operable to move with respect to the one or more air induction channels 630. In this example, the movable plate 620 is operable to rotate around an axis 1004 of the fluid delivery device 500 with respect to a remainder of the fluid delivery device 500 upon user actuation. The axis 1004 passes through and is aligned substantially perpendicular to a center of the spray face 554.

The movable plate 620 is perforated with one or more through thickness apertures 640 arranged to selectively align with the one or more air induction channels 630.

The movable plate 620 is operable to be actuated between a first state and a second state. FIG. 10 shows the conduit assembly 600 wherein the movable plate 620 is in the first state. In this state, the movable plate 620 is arranged such that the one or more through thickness apertures 640 at least partially align with the one or more air induction channels 630 thereby enabling airflow to the one or more air induction channels 630. As such, in this state, the air induction channels 630 open and air may be conveyed along the one or more air induction channels 630 from outside the conduit 601 into the conduit 601. In this state, the fluid stream downstream of the flow constrictor 602 is said to be an aerated fluid stream.

When the movable plate 620 is arranged in the second state, the one or more through thickness apertures 640 are completely misaligned with the one or more air induction channels 630 thereby preventing airflow to the one or more air induction channels 630. As such, in this state, the one or more air induction channels 630 are closed and air cannot be conveyed along the one or more air induction channels 630 from outside the conduit 601 into the conduit 601. As a result, in this state, the fluid stream downstream of the flow constrictor 602 is not an aerated fluid stream.

The movable plate 620 may include a grip (not shown) to enable user actuation of the movable plate 620 between the first state and the second state. This configuration may allow the moveable plate to be set in either the first sate or the second state during assembly thereby limiting the number of different components required to produce spray heads with different resultant flow characteristics.

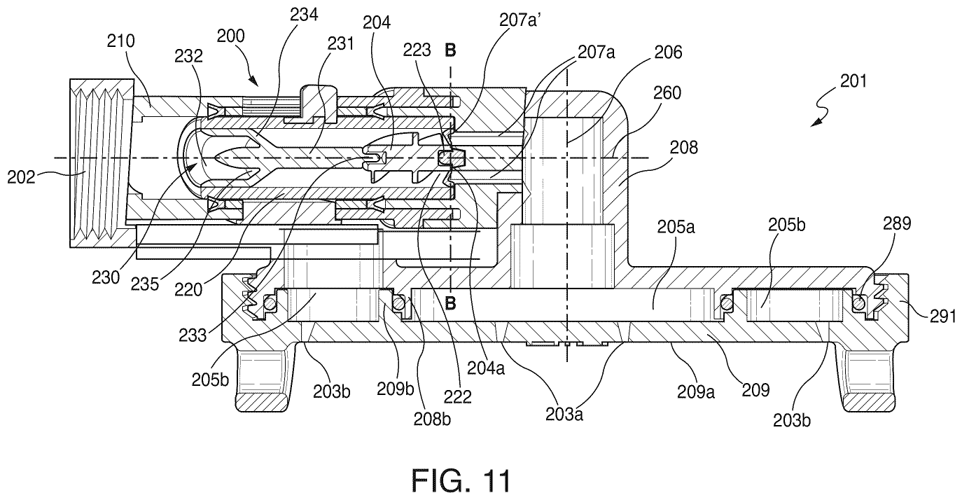

FIG. 11 shows a cross-sectional view of a fluid delivery device 201. In this example, the fluid delivery device 201 of FIG. 11 is substantially similar to the fluid delivery device 1 shown in FIG. 1. The fluid delivery device 201 differs from the fluid delivery device 1, in having a means for adjusting the position of the switching device relative to inlets of the first and second channels. This is achieved through the provision of an actuator assembly 200 in which a switching device is integrated.

The fluid delivery device 201 comprises a body 208 having an inlet 202, configured to couple to and receive fluid from a fluid supply pipe (not shown), and a plurality of fluid delivery outlets 203a, 203b in fluid communication with the inlet 202. The fluid delivery device 201 also includes a first chamber 205a leading to a first selection 203a of the plurality of outlets 203a, 203b and a second chamber 205b leading to a second selection 203b of the plurality of outlets 203a, 203b. At least one of the first selection of outlets 203a and the second selection of outlets 203b comprises more than one outlet.

The actuator assembly 200 forms part of a handle of the fluid delivery device 201. The actuator assembly 200 is disposed in a fluid path between the inlet 202 and the plurality of outlets 203a, 203b and is configured to receive fluid from the fluid supply pipe (when in use). The actuator assembly 200 comprises a switching device 204 operable to control fluid flow to the plurality of outlets 203a, 203b.

The switching device 204 is configured such that it has a first operating mode in which there is a first fluid flow rate from the inlet 202 to the first chamber 205a and a second operating mode in which there is a second fluid flow rate from the inlet 202 to the second chamber 205b. In the first operating mode, the fluid flow rate from the inlet to the second chamber is not equal to the second fluid flow rate. During use of the fluid delivery device 201, the switching device 204 is caused to continuously cycle between the first operating mode and the second operating mode.

In this example, the first selection 203a of outlets and the second selection 203b of outlets each comprise more than one outlet. The first selection 203a of outlets and the second selection 203b of outlets each comprise numerous outlets arranged radially, in a ring, about a central axis 206 of the fluid delivery device 201. The central axis 206 passes through a centre of a spray face 209a, normal to the spray face 209a at this point. The cross-sectional view of FIG. 1 shows only two outlets of each of the first selection 203a of outlets and the second selection 203b of outlets.

The first chamber 205a is connected to the inlet 202 and the switching device 204 via one or more channels 207a, termed first channels 207a. Similarly, the second chamber 205b is connected to the inlet 202 and the switching device 204 via one or more channels (not shown), termed second channels.

The body 208 comprises two first channels 207a and two second channels (not shown). The first and second channels 207a are alternately spaced around a section of the body 208 such that the two first channels 207a lie opposite one another and the two second channels also lie opposite one another.

In this example, the switching device 204 is a moveable element which rotates relative to the body 208. The switching device 204 may be a turbine or screw threaded rod and may, at certain positions, partially or completely close openings to the first channels 207a and/or the second channels. Alternately, the switching device 204 may not completely close openings to the first channels 207a and/or the second channels at any position during its rotation. This may ensure there is always non-zero flow rate through both the first channels 207a and the second channels. In this example, the switching device 204 is a turbine disposed in a fluid path between the inlet 202 and the plurality of outlets 203a, 203b, and is coaxial with the inlet 202.

In this example, the switching device 204 is a turbine having two fold symmetry down its axis. The configuration of the switching device 204 and the arrangement of the first and second channels 207a, enables a phase of flow in one of the two first channels 207a to be the same as in the other of the first channels 207a. Similarly a phase of flow in one of the two second channels may be the same as in the other of the second channels.

Fluid flow rates to each of the first and second channels 207a are defined by inlet water pressure and size of opening between the switching device 204 and the respective channel 207a. The relevant opening being between the respective channel 207a and a turbine blade which eclipses said channel 207a.

In FIG. 11, the fluid delivery device 201 is shown with the switching device 204 in the first operating mode. In this mode, the fluid flow rate from the inlet 202 to the first chamber 205a is the first fluid flow rate. The fluid flow rate from the inlet 202 to the second chamber 205b is not equal to the second fluid flow rate. Upon rotation of the switching device 204, the switching device 204 switches from its first operating mode to its second operating mode and the openings between the blades of the turbine and the first and second channels 207a change. The fluid flow rate from the inlet 202 to the second chamber 205b changes to the second fluid flow rate. The fluid flow rate from the inlet 202 to the first chamber 205a also changes such that it is not equal to the first fluid flow rate.

As the turbine continuously rotates, the switching device (turbine) 204 continuously cycles between the first operating mode and the second operating mode. This may be beneficial, as a pulsing flow may be achieved, which may provide a suitable sense of water pressure to a user while minimising total water use. The fluid delivery device 201 may be configured such that, in use, the switching device 204 may rotate at approximately 200 revolutions per minute. A short pulse interval time may prevent a user from being aware that the flow rate from individual outlets is fluctuating. The provision of two selections of outlets 203a, 203b with temporally offset flow rate variation may further mask flow rate variation to a user of the fluid delivery device 201.

In this embodiment, the switching device 204 is not powered, though in other embodiments it may be powered. The switching device 204 is driven solely by fluid flow through the fluid delivery device 201. This may minimise the complexity, cost of manufacture and energy consumption of such a device, while improving safety to a user. In this way, cycling of the switching device 204 between the first operating mode and the second operating mode may be automatic and continuous.

A resultant flow pattern of the fluid delivery device 201 may be varied by changing the shape and number of turbine blades of the switching device 204. For example, the number or pitch of blades may vary the pulse interval period for a given inlet fluid pressure.

The actuator assembly 200 comprises a first piece 210, a second piece 220 and a third piece 230. In this example, both the first piece 210 and the second piece 220 are generally tubular. The second piece 220 is received within the first piece 210 such that the first piece 210 surrounds the second piece 220. The switching device 204 is received within the second piece 220. An end of the second piece 220 distal from the inlet 202 includes an end plate 222. The end plate 222 comprises a series of perforations each aligned with one of the first and second channels 207a to allow fluid flow therebetween. The end plate 222 further comprises a central projection 223 arranged to axially support the switching device 204 in use as it rotates. The central projection 223 is rounded and located in line with a central axis 260 of the actuator assembly 200. The projection 223 extends toward the inlet 202 from a plane (shown by line B-B in FIG. 11) comprising inlets 207a′ of the first and second channels 207a. After assembly, the projection 223 is received within a hollow 204a of the switching device 204.

The third piece 230 of the actuator assembly is positioned within the second piece 220 and includes a shaft 231 and a halo 232. The shaft 231 is located along the central axis of the actuator assembly 200. A first end of the shaft 231 proximal to the inlet 202 is fixed to the supporting halo 232 by way of one or more struts 234. The halo 232 is generally tubular in shape and configured to fit within and couple to an interior surface of the second piece 220. One or more passages 235 are formed between the halo 232 and the shaft 232. The passages 235 allow for fluid flow from the inlet 202 to the switching device 204.

A second end of the shaft distal from the inlet 202 forms an additional projection 233 which further supports the turbine while allowing the switching device 204 to rotate relative to the third piece 230.

The fluid delivery device 201 may be configured to allow replacement of the switching device 204 and/or of the actuator assembly 200. This may allow the flow pattern of the fluid delivery device 201 to be chosen for a given application.

In this example, the actuator assembly 200 is separable from the body 208. The inlet 202 is configured to selectively couple to the fluid supply pipe or an adapter thereon (not shown) by means of a screw thread. The fluid delivery device is configured to allow the third piece 230 and the switching device 204 to be removed or inserted from/into the inlet 202. This may enable the actuator assembly to be assembled and disassembled with ease allowing the switching device 204 to be replaced with an alternate switching device if desired.

As shown in FIG. 11, the fluid delivery device 201 further comprises a detachable spray plate 209 including the spray face 209a in which the plurality of outlets 203a, 203b are disposed. Each of the plurality of outlets 203a, 203b may be connected to a respective through hole spanning the full thickness of the spray plate 209. In this way, each of the first selection 203a of outlets may be fluidically connected to the first chamber 205a and each of the second selection 203b of outlets may be fluidically connected to the second chamber 205b. The spray plate 209 may comprise a plurality of nozzles (not shown), each of which fluidically connect to a respective one of the plurality of outlets 203a, 203b.

The spray plate 209 is generally planar and circular with a flange 291 extending from its perimeter, in a direction away from the spray face 209a. An internal surface of the flange 291 is threaded and couples to a corresponding threaded portion of an external surface of the body 208. This may allow the spray plate 209 to be replaced, for example, by an alternate spray plate 209 having a different pattern or number of outlets 203a, 203b. This may improve the level of customisation of the fluid delivery device 201.

A back face of the spray plate 209, opposite the spray face 209a, partially bounds the first chamber 205a and the second chamber 205b. The spray plate 209 comprises a series of first protrusions 209b which extend from the back face in a direction generally away from the spray face 209a. Similarly, the body 208 comprises a series of second protrusions 208b which extend away from the remainder of the body 208 towards the spray face 209a. Each first protrusions 209b is configured to cooperate with a respective second protrusion 208b of the body 208. Together, the body 208, back face of the spray plate 209, and first and second series of protrusions 209b, 208b form the first and second chambers 205a and 205b. A seal 289 such as an O-ring may be positioned, between each first protrusion 209b of the spray face 209 and its respective second protrusion 208b of the body 208, to prevent fluid escaping from the first chamber 205a and/or the second chamber 205b during use. The second chamber 205b extends in an annulus around the first chamber 205a.

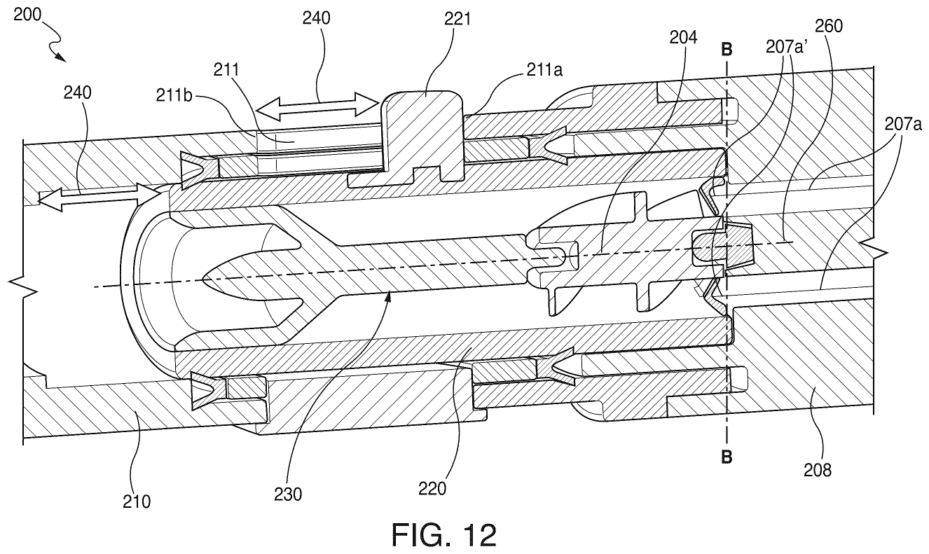

FIG. 12 is an enlarged view of a cross-section of the actuator assembly 200. As shown, the second piece 220 and third piece 230 are operable to translate with respect to the first piece 210. In this example, the second and third pieces 220, 230 are operable to translate along the central axis 260 of the actuator assembly 200. This translation is shown in FIG. 12 by double headed arrows 240.

The second piece 220 includes a grip 221 for user actuation of the actuator assembly 200. In this example, the grip 221 comprises a projection which extends outside of the first piece 210 to enable user sliding of the second and third pieces 220, 230 with respect to the first piece 210. The grip 221 is received with a slot 211 which is arranged parallel to the central axis 260 of the actuator assembly 200. In use, the slot 211 acts to prevent rotation of the first part 210 with respect to the second part 220. The slot 211 has a first end 211a and a second end 211b which each limit the extent of axial sliding between these two parts 210, 220.

The first piece 210 is fixedly coupled to the body 208. As such, translation of the second and third pieces 220, 230 along the central axis 260 changes the relative position of the switching element 204 and the inlets 207a′ of the first and second channels 207a.

In FIG. 12, the actuator assembly 200 is shown in a first terminal position where the grip 221 has been slid to contact the first end 211a of the slot 211. In this position, there is a minimum gap between the switching device 204 and the plane (shown by line B-B) comprising inlets 207a′ of the first and second channels 207a. In this example, the actuator assembly 200 is configured such that in the first terminal position there is no gap between the switching device 204 and the plane B-B.

This arrangement may provide distinct pulses to each of the first and second channels 207a as the switching device 204 rotates continuously during use.

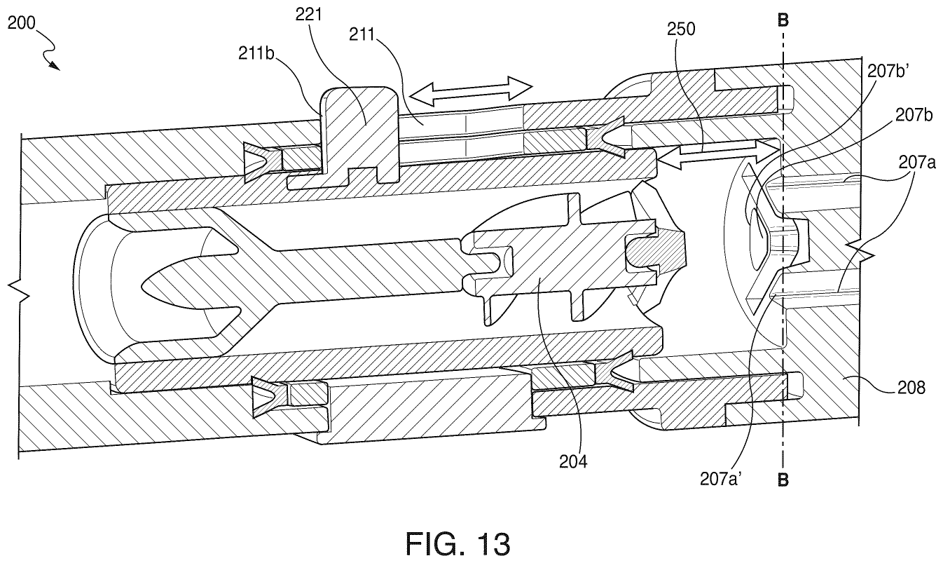

FIG. 13 shows a cross-sectional view of the actuator assembly 200 when the actuator assembly 200 is in a second terminal position. In this Figure, one of the second channels 207b of the body 208 can be seen.

In the second terminal position, the grip 221 has been slid to contact the second end 211b of the slot 211. There is a maximum gap 250 between the switching device 204 and the plane (shown by line B-B) comprising inlets 207a′, 207b′ of the first channels and second channels 207a, 207b. The maximum gap 250 may be greater than or equal to 3 mm, 5 mm or 10 mm. The maximum gap 250 may be less than or equal to 5 mm, 10 mm or 20 mm.

This arrangement may provide diffuse pulses to each of the first and second channels 207a, 207b as the switching device 204 rotates continuously during use. As such, there may be less variation in the flow to each of the first and second chambers over time as the switching device 204 rotates than when the actuator assembly 200 is in the first terminal position.

The actuator assembly 200 may be operable in any number of positions between the first terminal position and the second terminal position. This may allow a user to select from a continuous range of diffusivity of the flow pulsing.

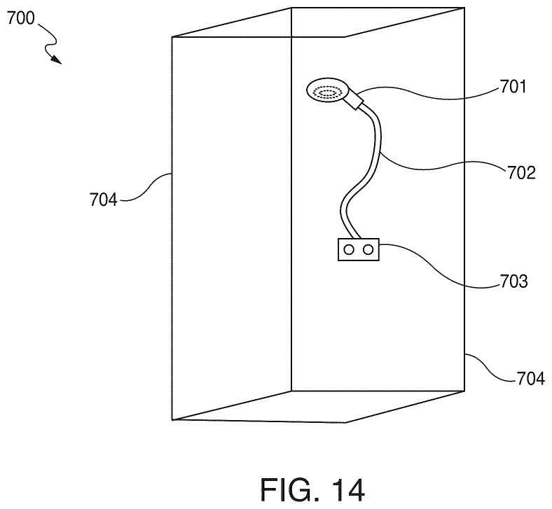

FIG. 14 shows an ablutionary system 700 comprising a fluid delivery device 701. The fluid delivery device 701 may be any suitable fluid delivery device within the scope of this disclosure such as the fluid delivery device 1, the fluid delivery device 10 or the fluid delivery device 10′. The ablutionary system 700 further comprises a fluid supply pipe 702 fluidically connected to the fluid delivery device 701. The fluid supply pipe 702 may be releasably connected to the fluid delivery device 701 by any suitable means, such as co-operating screw threads or snap fit connectors. The fluid supply pipe 702 is configured to supply fluid from a fluid source such as a mixer valve 703 to the fluid delivery device 701.

One or more panels 704 may partially or completely bound the ablutionary system 700. In this example, the fluid delivery device 701 is a showerhead and the ablutionary system 700 is a shower system. The panels 704 define at least partially a shower enclosure. One or more of the panels 704 may include a wall of an ablutionary environment.

The ablutionary system 700 may be any suitable ablutionary system and it will be appreciated that the teaching of the present disclosure may be applied to other plumbing systems such as, for example, a fire sprinkler system.

A first aspect provides a fluid delivery device comprising: an inlet for receiving fluid from a fluid supply pipe; a plurality of outlets in fluid communication with the inlet; two or more chambers including a first chamber, arranged to supply fluid to a first selection of the plurality of outlets, and a second chamber arranged to supply fluid to a second selection of the plurality of outlets; and a switching device disposed between the inlet and the two or more chambers, the switching device being operable to control fluid flow to the plurality of outlets; wherein the switching device is configured such that it has a first operating mode in which there is a first fluid flow rate from the inlet to the first chamber and a second operating mode in which there is a second fluid flow rate from the inlet to the second chamber; wherein, in the first operating mode, a fluid flow rate from the inlet to the second chamber is not equal to the second fluid flow rate; and wherein during use of the fluid delivery device the switching device is caused to cycle between the first operating mode and the second operating mode.

By cycling, e.g. continuously cycling, between the first operating mode and the second operating mode, the spray head may provide, in use, a suitable sense of fluid pressure. If the cycling between the first operating mode and the second operating mode is fast enough, then the user may not perceive the cycling between the first operating mode and the second operating mode and may feel as though they are experiencing water from both the first selection of the plurality of outlets and from the second selection of the plurality of outlets together. By cycling between the first operating mode and the second operating mode, the spray head may provide, in use, a suitable sense of fluid pressure to a user, while reducing or minimising total fluid use.

At least one of the first selection of the plurality of outlets and the second selection of the plurality of outlets may comprise a plurality of outlets.

The second fluid flow rate may be less than the first fluid flow rate.

Alternately, the second fluid flow rate may be more than or equal to the first fluid flow rate.

The fluid delivery device may be configured such that, in the second operating mode, a fluid flow rate from the inlet to the first chamber is not equal to the first fluid flow rate.

The first fluid flow rate and the second fluid flow rate may be non-zero.

The fluid delivery device may be configured such that, in the first operating mode there is non-zero fluid flow from the inlet to the second chamber. Additionally or alternatively, the fluid delivery device may be configured such that, in the second operating mode, there is non-zero fluid flow from the inlet to the first chamber.

In the first operating mode, there may be no fluid flow from the inlet to the second chamber.

In the second operating mode, there may be no fluid flow from the inlet to the first chamber.

Either the first selection of the plurality of outlets or the second selection of the plurality of outlets may consist of a single outlet.

At least one of the plurality of outlets may be common to both the first selection of the plurality of outlets and the second selection of the plurality of outlets.

None of the plurality of outlets may be common to both the first selection of the plurality of outlets and the second selection of the plurality of outlets.

Cycling between the first operating mode and the second operating mode may be driven by purely structural means using no computerised logic.

The first chamber and/or the second chamber may have any suitable shape.

The first chamber and/or the second chamber may be arcuate at least in part and may extend around a perimeter of the fluid delivery device.

One of the first chamber and the second chamber may be partially or completely circumferentially received within the other of the first chamber and the second chamber.

The fluid flow device may comprise one or more further selections of the plurality of outlets. The fluid flow device may be configured such that fluid supply to the one or more further selections of the plurality of outlets bypasses the switching device.

The fluid delivery device may comprise one or more further chambers, wherein one or more of the further chambers is/are configured to provide fluid flow from the switching device to one of the one or more further selections of the plurality of outlets.

In an implementation, the switching device and/or any part thereof may not move, by translation or rotation or otherwise, relative to the remainder of the fluid delivery device during continuous cycling between the first operating mode and the second operating mode.

The switching device may be a fluidic oscillator.

The fluid delivery device may comprise two or more channels each configured to fluidically connect the switching device to a respective one of the two or more chambers.

In at least one operating mode, the switching device may be fluidically connected to the first chamber by a first channel. In at least one operating mode, the switching device may be fluidically connected to the second chamber by a second channel.

The switching device may comprise an antechamber fluidically connected to the first chamber by a first channel of the one or more channels. The antechamber may be fluidically connected to the second chamber by a second channel of the one or more channels. The switching device may comprise a first feedback loop which provides a path for fluid flow from the first channel to the antechamber. The switching device may comprise a second feedback loop which provides a path for fluid flow from the second channel to the antechamber.

The first channel and the second channel may be connected to different sides, e.g. opposing sides, of the antechamber. The first feedback loop and/or the first channel may be connected to a first side of the antechamber. The second feedback loop and/or the second channel may be connected to a second side of the antechamber.

The switching device may be configured such that fluid flow from the first feedback loop disrupts fluid flow to the first channel, thereby switching the switching device from its first operating mode into its second operating mode. The switching device may be configured such that fluid flow from the second feedback loop disrupts fluid flow to the second channel, thereby switching the switching device from its second operating mode into its first operating mode.

The first feedback loop may be configured such that, during use, fluid flow from the first feedback loop enters the antechamber in a direction pointing substantially towards the or a second side of the antechamber. The second feedback loop may be configured such that fluid flow from the second feedback loop enters the antechamber in a direction pointing substantially towards the or a first side of the antechamber.

In an implementation, the switching device may comprise or consist of a movable element configured to block at least partially and unblock at least partially in a continuous cycle fluid flow from the inlet to the first chamber and fluid flow from the inlet to the second chamber such that, in use, the switching device continuously cycles between the first operating mode and the second operating mode.

The movable element may be unpowered. Movement of the movable element may be driven only by fluid flow from the inlet.

Alternatively, the movable element may be powered. For instance, movement of the movable element may be driven by a motor.

The movable element may be rotatable.

The movable element may comprise or consist of a turbine. The turbine may comprise or consist of one or more curved blades fixedly connected to a shaft which is oriented parallel to an axis of rotation of the turbine.

The movable element may be removable.

In the first operating mode, the switching device partially or completely closes openings to the first channel. In the second operating mode, the switching device partially or completely closes openings to the second channel.

The fluid delivery device comprises two or more chambers (including the first chamber and the second chamber). For example, the fluid delivery device may comprise three, four, five or ten chambers.

The plurality of outlets includes two or more selections of outlets (including the first selection of the plurality of outlets and the second selection of the plurality of outlets). For example, the plurality of outlets may include three, four, five or ten selections of the plurality of outlets.

The switching device may be configured such that it has three or more operating modes (including the first operating mode and the second operating mode). For example, switching device may be configured such that it has three, four, five or ten operating modes.

Each of the three or more operating modes may be associated with a respective one of the two or more chambers. The switching device may be configured such that in any given operating mode of the three or more operating modes, there is a given non-zero fluid flow rate from the inlet to the one of the two or more chambers associated with that operating mode. For example, when the switching device is in a third operating mode of the three or more operating modes, there may be a third fluid flow rate from the inlet to a third chamber of the two or more chambers. When the switching device is in a fourth operating mode of the three or more operating modes, there may be a fourth fluid flow rate from the inlet to a fourth chamber of the two or more chambers.

The valve device may be configured such that in any given operating mode of the three or more operating modes:
a. there is a given fluid flow rate from the inlet to the chamber of the three or more chambers associated with that given operating mode; and
b. for each of the remaining chambers of the three or more chambers, there is a respective alternate fluid flow rate from the inlet to that one of the remaining chambers. The alternate fluid flow rate may be less than or greater than, but not equal to, the given non-zero fluid flow rate that occurs when the switching device is operating in the one of the three or more operating modes associated with that remaining chamber. Some or all of the alternate fluid flow rates may be zero.

During use of the fluid delivery device the switching device may be caused to cycle, e.g. to continuously cycle, between each of the three or more operating modes.

By cycling, e.g. continuously cycling, between the three or more operating modes, the spray head may provide, in use, a suitable sense of fluid pressure to a user, while reducing or minimising total fluid use.

Each of the two or more channels may be connected at different positions along an edge (e.g., a basal edge) of the antechamber.

The switching device may be configured such that fluid flow from the first feedback loop and/or the second feedback loop disrupts fluid flow to some of the two or more channels, thereby switching the switching device between the operating modes.

In an implementation, the moveable element may be configured to block at least partially and unblock at least partially in a cycle, e.g. a continuous cycle, fluid flow from the inlet to each of the two or more chambers such that, in use, the switching device cycles, e.g. continuously cycles, between the operating modes.

The fluid delivery device may comprise a spray plate having a spray face in which one or more of the outlets are disposed. The spray plate may be a detachable spray plate.

The fluid delivery device may comprise a spray head, e.g. a spray head for a shower or a faucet.

The fluid delivery device may be configured such that the switching device switches between its first and second operating modes at a rate of up to or at least 100 Hz, up to or at least 50 Hz, up to or at least 20 Hz, up to or at least 10 Hz, up to or at least 8 Hz, up to or at least 5 Hz, up to or at least 4 Hz or up to or at least 3 Hz.

The fluid may comprise, or consist essentially of, water, though the use of other fluids may occur in different example embodiments.

Inlets of each of the two or more channels may be arranged in a common plane.

The fluid delivery device may comprise an actuator assembly configured to enable adjustment of a position of the switching device relative to inlets of the two or more channels.

The actuator assembly may be disposed in a fluid path between the inlet of the fluid delivery device and the inlets of each of the two or more channels. The actuator assembly may be operable to receive fluid from the fluid supply pipe and supply fluid to the two or more channels via the switching device.

The switching device may be received within the actuator assembly.

The actuator assembly may include one or more passages for fluid flow from the inlet to the switching device.

The actuator assembly may include a first piece which forms an exterior surface of the fluid delivery device.

The actuator assembly may include a second piece which at least partially fits within the first piece.

The actuator assembly may include a third piece configured to support the switching device.

The second piece may be fixed with respect to the third piece.

The actuator assembly may be configured such that the second and third pieces are movable with respect to the first piece. For example, the second and third pieces may be operable to translate along a central axis of the actuator assembly.

The second piece may include a grip for user actuation of the actuator assembly. The grip may comprise a projection which extends outside of the first piece to enable a user to slide the second and third pieces with respect to the first piece.

The actuator assembly may be configured to prevent rotation of the second and third pieces with respect to the first piece.

The first piece may include a slot arranged to receive the projection. The slot may be configured to prevent rotation of the first part with respect to the second part. The slot may be arranged parallel to the central axis of the actuator assembly.

Translation of the second and third pieces along the central axis may change the relative position of the switching element and the inlets of the two or more channels.

Varying the relative position of the switching element and the inlets of the two or more channels may vary one or more characteristics of flow from the plurality of outlets.

The slot may have a first end and a second end opposite the first end. The grip may be operable between a first terminal position, where the grip has been slid to contact the first end of the slot, and a second terminal position where the grip has been slid to contact the second end of the slot.

When the grip is in the first terminal position there may be a minimum gap between the switching device and the inlets of the two or more channels. For example, when the grip is in the first terminal position there may be no gap between the switching device and the inlets of the two or more channels.

When the grip is in the first terminal position the fluid delivery device may provide distinct pulses to each of the two or more channels as the switching device rotates, e.g. rotates continuously, during use.

When the grip is in the second terminal position there may be a maximum gap between the switching device and the inlets of the two or more channels. The maximum gap may be greater than or equal to 3 mm, 5 mm or 10 mm. The maximum gap may be less than or equal to 5 mm, 10 mm, 20 mm or 30 mm.

When the grip is in the second terminal position the fluid delivery device may provide diffuse pulses to each of the two or more channels as the switching device rotates, e.g. rotates continuously, during use.

The grip may be operable in any number of positions between the first terminal position and the second terminal position. This may allow a user to select from a continuous range of diffusivity of flow pulsing.

The second piece may be substantially tubular in shape and positioned within the first piece. The third piece and/or the switching device may be received within the second piece.

An end of either of the second or third piece distal from the inlet of the fluid delivery device may include an end plate. The end plate may comprise a series of perforations each aligned with one of the two or more channels to allow fluid flow therebetween.

The end plate may comprise a central projection arranged to axially support the switching device in use as it rotates.

The central projection may be rounded and located in line with the central axis of the actuator assembly.

The third piece may include a shaft located along the central axis of the actuator assembly. The third piece may include a halo secured to the shaft by one or more struts. The halo may be generally tubular in shape and configured to fit within and couple to an interior surface of the second piece.

The one or more passages of the actuator assembly may be formed between the halo and the shaft.

In an alternate configuration, the switching device may be transitionally fixed with respect to the first piece and the inlets of the one or more channels may be operable to translate. In this configuration, the second piece may be fixed with respect to the inlets of the two or more channels such that sliding the grip translates the inlets of the two or more channels thereby adjusting the position of the switching device relative to inlets of the first and second channels.

The second piece and the third piece may be integrally formed together and consist of a single element. Alternately, the second piece and the third piece may be two distinct components that are fixedly connected (e.g., by an adhesive).

The fluid delivery device may be configured to allow replacement of the switching device and/or of the actuator assembly. This may allow the flow pattern of the fluid delivery device to be chosen for a given application.

The actuator assembly may form part of a handle of the fluid delivery device.

A second aspect provides a conduit assembly including: a conduit configured to convey a fluid stream; a flow constrictor configured to constrict flow of the fluid stream along the conduit, thereby producing, in use, a pressure drop in the fluid stream downstream of the flow constrictor; one or more air induction channels for conveying a stream of air from outside the conduit into the conduit at one or more locations downstream of the flow constrictor; and an air induction channel closure means operable between a first state, in which one or more of the air induction channels are open and a second state, in which one or more of the air induction channels are closed; wherein: when the air induction channel closure means is in the first state, the pressure drop in the fluid stream downstream of the flow constrictor causes one or more streams of air to be drawn along the open air induction channel(s), wherein the one or more streams of air mix with the fluid stream in the conduit to form an aerated fluid stream; and when the air induction channel closure means is in the second state, no streams of air are conveyed along the closed air induction channel(s) from outside the conduit into the conduit.

The air induction channel closure means may be operable to translate relative to the conduit. For instance, the air induction channel closure means may be operable to translate relative to the conduit in a direction parallel to a longitudinal axis of the conduit.

In an implementation, the air induction channel closure means may comprise a sleeve.

The air induction channel closure means may further comprise a grip means to facilitate manual actuation between the first state and the second state.

The grip means may comprise a ridge. The ridge may have a crescent or arcuate shape at least in part.

The conduit assembly may be made from two parts, e.g. a first part and a second part, which are configured to couple selectively to one another.

Either or both of the first part and the second part may be substantially tubular in shape.

An end of the first part proximal to the second part may form a reduced radius portion which has a smaller external radius than a remainder of the first part.

An end of the second part proximal to the first part may form an increased radius portion which has a larger internal radius than a remainder of the second part.

One or more threaded portions may be disposed on an external surface of the reduced radius portion and/or on an internal surface of the increased radius portion.

The first part may be configured to fit at least partially within and engage the second part to couple selectively the first and second parts of the conduit.

The flow constrictor may form one end of a hollow insert.

The conduit assembly may be configured such that the hollow insert is located within the first part. For example, the hollow insert may be located within the reduced radius portion. The hollow insert may include a radially projecting rim distal to the flow constrictor.

The conduit assembly may be configured such that the rim is sandwiched between the first part and the second part.

The one or more air induction channels may include a first set of air induction passages which perforate the first part of the conduit.

The one or more air induction channels may include a second set of air induction passages which perforate the hollow insert.

Each of the second set of air induction passages may be arranged to receive air from a respective one of the first set of air induction passages and provide air to an interior of the hollow insert.

The first set and second set of air induction passages may each include one or more air induction passages. For example, the first set of air induction passages may include greater than or equal to 2, greater than or equal to 4, greater than or equal to 8, greater than or equal to 10 or greater than or equal to 16 air induction passages and/or less than or equal to 32, less than or equal to 18, less than or equal to 16, less than or equal to 10 or less than or equal to 8 air induction passages. The second set of air induction passages may include greater than or equal to 2, greater than or equal to 4, greater than or equal to 8, greater than or equal to 10 or greater than or equal to 16 air induction passages and/or less than or equal to 32, less than or equal to 18, less than or equal to 16, less than or equal to 10 or less than or equal to 8 air induction passages.

The first set of air induction passages may be regularly distributed around a circumference of the first part (optionally the reduced radius portion). The second set of air induction passages may be regularly distributed around a circumference of the second part (optionally the increased radius portion). In other example embodiments, irregular distributions of air induction passages may be used.

The conduit assembly may be configured such that air may enter the hollow insert immediately downstream of the flow constrictor. Alternate locations may be employed in some example embodiments.

The conduit assembly may be configured such that when the air induction channel closure means is in the first state, a gap is present between a front end of the air induction channel closure means, proximal to the second part, and the second part, thereby opening up the air induction channels.

The conduit assembly may be configured such that when the air induction channel closure means is in the second state, the front end of the air induction channel closure means contacts the second part, thereby sealing the front end of the air induction channel closure means against the second part.

Two sealing members may be disposed on an external surface of the reduced radius portion on either side of the first set of air induction passages. A first of these two sealing members, distal from the second part, may act to prevent air from entering the conduit via the gap between a rear end of the air induction channel closure means and the first part.

An internal radius of the air induction channel closure means may increase towards the front end of the air induction channel closure means. When the air induction channel closure means is in the first state, there may be a clearance between a second of the two sealing members and the air induction channel closure means.

When the air induction channel closure means is in the second state, each of the two sealing members may inhibit or prevent fluid (e.g., air or water) from flowing between the reduced radius portion and the air induction channel closure means.

When the air induction channel closure means is in the second state, the second sealing member may act as a secondary seal to prevent air from entering into the conduit between the front end of the air induction channel closure means and the second part.

The conduit assembly may be integrated into a support pipe configured to fix a fluid delivery device with respect to a shower enclosure in which the fluid delivery device is installed.

The conduit assembly may be configured to be integrated into a spray head of a fluid delivery device.

The flow constrictor may comprise a section of the conduit wherein a cross-sectional area progressively narrows in a direction of the fluid stream.

The conduit may be perforated by one or more air induction channels for conveying a stream of air from outside the conduit into the conduit.

The air induction channel closure means may comprise a movable plate. The moveable plate may be operable to actuate the conveyance of air along the one or more air induction channels.

The movable plate may form a rear external surface of the spray head.

The movable plate may be operable to move with respect to the one or more air induction channels. For example, the movable plate may be operable to rotate around an axis of the fluid delivery device. The axis may pass through and be aligned substantially perpendicular to a center of a spray face of the spray head.

When the air induction channel closure means is in the first state, the movable plate may be arranged such that the one or more through thickness apertures at least partially align with the one or more air induction channels thereby enabling airflow to the one or more air induction channels. As such, in this state, the air induction channels may be open.

When the air induction channel closure means is in the second state, the one or more through thickness apertures may be completely misaligned with the one or more air induction channels thereby preventing airflow to the one or more air induction channels. As such, in this state, the one or more air induction channels may be closed.

The movable plate may include a grip to enable user actuation of the movable plate between the first state and the second state.

The fluid delivery device of the first aspect may comprise the conduit assembly of the second aspect.

The fluid delivery device may comprise or essentially consist of a handheld shower or a fixed overhead shower.

The fluid delivery device may comprise a spray head for a shower.

The conduit assembly may be integrated into a support pipe that fixes the fluid delivery device with respect to a shower enclosure in which the fluid delivery device is installed.

The flow constrictor may comprise a section of the conduit wherein a cross-sectional area progressively narrows in a direction of the fluid stream.

The conduit may be perforated by one or more air induction channels for conveying a stream of air from outside the conduit into the conduit.

The air induction channel closure means may comprise a movable plate. The moveable plate may be operable to actuate the conveyance of air along the one or more air induction channels.

The movable plate may form a rear external surface of the spray head.

The movable plate may be operable to move with respect to the one or more air induction channels. For example, the movable plate may be operable to rotate around an axis of the fluid delivery device. The axis may pass through and be aligned substantially perpendicular to a center of a spray face of the spray head.

When the air induction channel closure means is in the first state, the movable plate may be arranged such that the one or more through thickness apertures at least partially align with the one or more air induction channels thereby enabling airflow to the one or more air induction channels. As such, in this state, the air induction channels may be open.

When the air induction channel closure means is in the second state, the one or more through thickness apertures may be completely misaligned with the one or more air induction channels thereby preventing airflow to the one or more air induction channels. As such, in this state, the one or more air induction channels may be closed.

The movable plate may include a grip to enable user actuation of the movable plate between the first state and the second state.

A third aspect provides a plumbing system comprising: a fluid delivery device according to the first aspect; and a fluid supply pipe configured to connect fluidically the fluid delivery device to a fluid source.

The fluid source may include a mixer valve or an instantaneous water heater.

The plumbing system may be an ablutionary system, e.g. a shower system or a faucet system.

The ablutionary system may be disposed at least partially within a shower and/or bath enclosure.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

This disclosure is intended to be read such that any separable features or elements of the disclosed invention, in any of its various example configurations, should be viewed as intended to be combinable unless the context clearly dictates otherwise.

As will be apparent to those skilled in the art, a fluid delivery device according to the present disclosure may have any arrangement of outlets distributed across at least a portion of a spray plate of any size and/or shape. For instance, the outlets may include one or more selections of outlets that are arranged so as to form an arc, a ring, a stripe, a zig-zag or any other shape.

Throughout the disclosure, the term turbine is used to mean a rotatable element with blades, through which fluid flows to rotate the turbine.

It will be understood that the invention is not limited to the embodiments described above. Various modifications and improvements can be made without departing from the concepts disclosed herein. Except where mutually exclusive, any of the features may be employed separately or in combination with any other features and the disclosure extends to all combinations and sub-combinations of one or more features disclosed herein.

1. A fluid delivery device comprising:
an inlet for receiving fluid from a fluid supply pipe;
a plurality of outlets in fluid communication with the inlet;
two or more chambers including a first chamber and a second chamber, the first chamber suppling fluid to a first selection of the plurality of outlets, and the second chamber suppling fluid to a second selection of the plurality of outlets; and
a switching device disposed between the inlet and the two or more chambers, the switching device controlling fluid flow to the plurality of outlets;
wherein the switching device has a first operating mode in which there is a first fluid flow rate from the inlet to the first chamber and a second operating mode in which there is a second fluid flow rate from the inlet to the second chamber;
wherein, in the first operating mode, a fluid flow rate from the inlet to the second chamber is not equal to the second fluid flow rate; and
wherein during use of the fluid delivery device the switching device cycles between the first operating mode and the second operating mode.

2. The fluid delivery device of claim 1, wherein at least one of the first selection of the plurality of outlets and the second selection of the plurality of outlets comprises a plurality of outlets.

3. The fluid delivery device of claim 1, wherein the second fluid flow rate is less than the first fluid flow rate.

4. The fluid delivery device of claim 1, wherein in the second operating mode, a fluid flow rate from the inlet to the first chamber is not equal to the first fluid flow rate.

5. The fluid delivery device of claim 1, wherein, in the first operating mode, there is either:
non-zero fluid flow from the inlet to the second chamber; or
no fluid flow from the inlet to the second chamber.

6. The fluid delivery device of claim 1, wherein, in the second operating mode, there is non-zero fluid flow from the inlet to the first chamber.

7. The fluid delivery device of claim 1, wherein, in the second operating mode, there is no fluid flow from the inlet to the first chamber.

8. The fluid delivery device of claim 1, wherein either the first selection of the plurality of outlets or the second selection of the plurality of outlets consists of a single outlet.

9. The fluid delivery device of claim 1, wherein at least one of the plurality of outlets is/are common to both the first selection of the plurality of outlets and the second selection of the plurality of outlets.

10. The fluid delivery device of claim 1, wherein the switching device and/or any part thereof does not move, by translation or rotation or otherwise, relative to a remainder of the fluid delivery device during cycling between the first operating mode and the second operating mode.

11. The fluid delivery device of claim 1, further including two or more channels, each fluidically connecting the switching device to a respective one of the two or more chambers, wherein the two or more channels include:
a first channel between the switching device and the first chamber;
a second channel between the switching device and the second chamber.

12. The fluid delivery device of claim 11, comprising an actuator assembly enabling adjustment of a position of the switching device relative to inlets of the two or more channels.

13. The fluid delivery device of claim 11, wherein the switching device includes an antechamber fluidically connected to the first chamber by the first channel and fluidically connected to the second chamber by the second channel.

14. The fluid delivery device of claim 13, wherein the switching device includes a first feedback loop which provides a path for fluid flow from the first channel to the antechamber and a second feedback loop which provides a path for fluid flow from the second channel to the antechamber.

15. The fluid delivery device of claim 14, wherein fluid flow from the first feedback loop disrupts fluid flow to the first channel, thereby switching the switching device from its first operating mode into its second operating mode; and wherein fluid flow from the second feedback loop disrupts fluid flow to the second channel, thereby switching the switching device from its second operating mode into its first operating mode.

16. The fluid delivery device of claim 1 further comprising a movable element selectively blocking at least partially, in a cycle fluid flow, the inlet to the first chamber and fluid flow from the inlet to the second chamber such that, in use, the switching device cycles between the first operating mode and the second operating mode.

17. The fluid delivery device of claim 16, wherein either:
movement of the movable element is driven only by fluid flow from the inlet; or
the movable element is powered.

18. The fluid delivery device of claim 14, wherein: in at least one operating mode, the switching device is fluidically connected to the first chamber by a first channel; in at least one operating mode, the switching device is fluidically connected to the second chamber by a second channel; in the first operating mode, the switching device partially or completely closes openings to the first channel; and, in the second operating mode, the switching device partially or completely closes openings to the second channel.

19. The fluid delivery device of claim 1, further including one or more further selections of the plurality of outlets, wherein:
fluid supply to the one or more further selections of the plurality of outlets bypasses the switching device; and/or
the fluid delivery device includes one or more further chambers, wherein each of the one or more further chambers provides fluid flow from the switching device to one of the one or more further selections of the plurality of outlets.

20. The fluid delivery device of claim 1 further including three or more chambers, wherein the switching device has three or more operating modes, and wherein during use of the fluid delivery device the switching device cycles between each of the three or more operating modes.

21. The fluid delivery device of claim 19, wherein each of the three or more operating modes is associated with a respective one of the three or more chambers;
wherein there is a given fluid flow rate from the inlet to the chamber of the three or more chambers associated with that given operating mode; and
for each of the remaining chambers of the three or more chambers, there is a respective alternate fluid flow rate from the inlet to that one of the remaining chambers.

22. The fluid delivery device of claim 1, further comprising a conduit assembly including:
a conduit;
a flow constrictor constricting flow of a fluid stream along the conduit, thereby producing, in use, a pressure drop in the fluid stream downstream of the flow constrictor;
one or more air induction channels for conveying a stream of air from outside the conduit into the conduit at one or more locations downstream of the flow constrictor; and
an air induction channel closure operable between a first state, in which one or more of the air induction channels are open and a second state, in which one or more of the air induction channels are closed;
wherein:
when the air induction channel closure is in the first state, the pressure drop in the fluid stream downstream of the flow constrictor causes one or more streams of air to be drawn along the open air induction channel(s), wherein the one or more streams of air mix with the fluid stream in the conduit to form an aerated fluid stream; and
when the air induction channel closure is in the second state, no streams of air are conveyed along the closed air induction channel(s) from outside the conduit into the conduit.

23. The fluid delivery device of claim 22, wherein the air induction channel closure translates relative to the conduit.

24. A plumbing system comprising:
an inlet;
a plurality of outlets in fluid communication with the inlet;
a first chamber in fluid communication with a first selection of the plurality of outlets, and a second chamber in fluid communication with a second selection of the plurality of outlets; and
a switching device between the inlet and the two or more chambers, the switching device controlling fluid flow to the plurality of outlets;
wherein the switching device has a first operating mode in which there is a first fluid flow rate from the inlet to the first chamber and a second operating mode in which there is a second fluid flow rate from the inlet to the second chamber, wherein in the first operating mode, a fluid flow rate from the inlet to the second chamber is not equal to the second fluid flow rate; and
wherein the switching device cycles between the first operating mode and the second operating mode; and
a fluid supply pipe configured to connect fluidically the inlet to a fluid source.

25. The plumbing system of claim 24, wherein the fluid source includes a mixer valve or an instantaneous water heater.
